(19) United States
(12) Patent Application Publication
(10) Pub. No.: US 2019/0144750 A1
(43) Pub. Date: May 16, 2019

(54) POLYMERIZABLE COMPOUND AND LIQUID CRYSTAL COMPOSITION CONTAINING THE SAME

(71) Applicant: DIC Corporation, Tokyo (JP)

(72) Inventors: Masanao Hayashi, Kitaadachi-gun (JP); Kenta Shimizu, Kitaadachi-gun (JP); Manabu Takachi, Kitaadachi-gun (JP); Tetsuo Kusumoto, Kitaadachi-gun (JP)

(73) Assignee: DIC Corporation, Tokyo (JP)

(21) Appl. No.: 16/092,274

(22) PCT Filed: Apr. 13, 2017
(86) PCT No.: PCT/JP2017/015102

§ 371 Date: Oct. 9, 2018

(30) Foreign Application Priority Data
Apr. 27, 2016 (JP) 2016-089247

(51) Int. Cl. C09K 19/12; C09K 19/20; C09K 19/38

(52) U.S. Cl. CPC C09K 19/12; C09K 19/54; C09K 19/3852; C09K 19/20

(57) ABSTRACT

The present invention provides an improved adhesion when a polymerizable liquid crystal composition is applied to a film substrate and cured, improved storage stability of the composition when the composition is used in a PSA display device, and a liquid crystal display device having improved display characteristics. The polymerizable compound is represented by general formula (I). The invention provides an optically anisotropic film using the polymerizable compound, and a liquid crystal display device using the polymerizable compound.

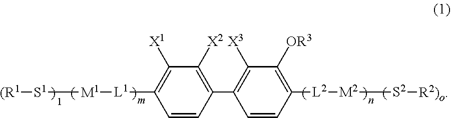

### TECHNICAL FIELD

The present invention relates to a polymerizable compound, a liquid crystal composition containing the compound, and a liquid crystal display device including an optically anisotropic body or a cured material that controls the alignment of the liquid crystal molecules, the optically anisotropic body being a cured material of the liquid crystal composition.

### BACKGROUND ART

With the progress of an information society, the importance of optical compensation films used for polarizers, retardation plates, and so forth essential for liquid crystal displays has recently been further increased. Examples of optical compensation films, which are required to have high durability and greater functionality, formed by polymerization of polymerizable liquid crystal compositions have been reported (see Patent Literatures 1 to 3). Regarding optically anisotropic bodies used for optical compensation films and so forth, for example, the polymerization rates, solubility, melting points, and glass transition points of compounds, and the transparency, mechanical strength, surface hardness, and heat resistance of polymers thereof are important factors in addition to optical properties. Optically anisotropic bodies are particularly useful for retardation plates of recent 3D displays and will be widely used. However, in the case where a polymerizable liquid composition is applied to a film substrate and cured, the adhesion is low, thus possibly decreasing the long-term reliability and productivity.

In recent years, polymer sustained alignment (PSA)-mode liquid crystal display devices and polymer stabilized vertical alignment (PSVA)-mode liquid crystal display devices have been developed as liquid crystal display devices having rapid response and high contrast. In each of the cases of PSA- and PSVA-mode liquid crystal display devices, liquid crystal molecules are aligned by applying a voltage between substrates, in some cases, while a polymerizable compound-containing liquid crystal composition containing a non-polymerizable liquid crystal composition and a polymerizable compound is arranged between the substrates. The polymerizable compound is polymerized by irradiation with ultraviolet light or the like while the liquid crystal molecules are aligned, thereby storing the alignment state of the liquid crystal in the cured material. In the case where this technique is applied to in-plane switching (IPS)-mode liquid crystal display devices, curing is performed in the no-voltage-applied state.

Such liquid crystal display devices still have problems as follows: reliability problems such as “image-sticking”, which occurs when the static image continues to be displayed for a prolonged period of time, and problems with storage stability and productivity based on production processes. The reliability problems are not simple and are caused by some combined factors. Specific examples thereof include (1) problems due to remaining polymerizable compounds, (2) problems due to a change in the tilt (a change in the pretilt angle) of the liquid crystal molecules, and (3) problems due to the degradation of the liquid crystal molecules and so forth by irradiation with ultraviolet light.

Regarding the reliability, in the case of using a polymerization initiator, the polymerization initiator and its decomposition product cause image-sticking and a decrease in the voltage holding ratio of a liquid crystal display device. Thus, there is a need for a polymerizable compound-containing liquid crystal composition in which the polymerization is completed at a small amount of ultraviolet light without using a photopolymerization initiator. It is also known that some image-sticking phenomena are attributed to a change in the pretilt angle of liquid crystal molecules in a polymerizable compound-containing liquid crystal composition. That is, if a polymer that is a cured material of a polymerizable compound is flexible, in the case of a display device including the polymer, a continued display of the same pattern for a prolonged period of time changes the structure of the polymer to change the pretilt angle. The change in pretilt angle greatly affects the response speed to cause image-sticking. To solve the (2), it is thus effective to use a polymerizable compound to be formed into a polymer having a rigid structure in which its polymer structure is not changed; however, because the low-temperature storage stability of the liquid crystal composition is degraded, there is also a need to improve the compatibility with the liquid crystal. If spacer groups are interposed between all ring structures and polymerizable functional groups in order to improve solubility, the rigidity of the molecules is decreased to decrease the ability to control the tilt of the liquid crystal molecules. In conventional polymerizable compound-containing liquid crystal compositions, as described above, the UV reactivity, the solubility, and the stability of pretilt angles are not satisfactory.

### CITATION LIST

### Patent Literature

PTL 1: Japanese Unexamined Patent Application Publication (Translation of PCT Application) No. 10-513457

PTL 2: Japanese Unexamined Patent Application Publication No. 2002-145830

PTL 3: Japanese Unexamined Patent Application Publication No. 11-130729

PTL 4: Japanese Unexamined Patent Application Publication No. 2003-307720

### SUMMARY OF INVENTION

### Technical Problem

It is an object of the present invention to improve the compatibility (storage stability) with a liquid crystal compound contained in a liquid crystal composition and to further reduce the amount of remaining unreacted polymer. It is another object of the present invention to provide a polymerizable liquid crystal composition having improved adhesion when the composition is applied to a film substrate and cured, improved storage stability when the composition is used in a PSA display device, and improved UV reactivity in which polymerization occurs for a short UV irradiation time or at a small amount of irradiation energy, and to provide a liquid crystal display device having improved display characteristics and a reduced amount of remaining unreacted polymer.

### Solution to Problem

To solve the foregoing problems, the inventors have conducted intensive studies and have found that the foregoing problems can be solved with a polymerizable compound having a specific structure solves. This finding has led to the completion of the present invention.

The present invention also provides a polymerizable composition containing the polymerizable compound, a polymerizable compound-containing liquid crystal composition containing the polymerizable compound, an optical anisotropic body composed of a polymer of the polymerizable compound-containing liquid crystal composition, a polymerizable compound-containing liquid crystal composition containing the polymerizable compound and a non-polymerizable liquid crystal compound, and a liquid crystal display device including a polymerizable compound-containing liquid crystal composition, the liquid crystal display device having a liquid crystal alignment ability provided by polymerizing the polymerizable compound in the polymerizable compound-containing liquid crystal composition.

### Advantageous Effects of Invention

An optically anisotropic body using a polymerizable compound or a composition containing the polymerizable compound of the present invention has good adhesion to a substrate and is useful for applications such as polarizers and retardation plates.

The polymerizable compound of the present invention has an appropriate reaction rate; thus, the amount of remaining unreacted polymer in polymerization can be reduced.

In the case of a liquid crystal display device having the liquid crystal alignment ability provided by polymerizing the polymerizable compound in the polymerizable compound-containing liquid crystal composition, the polymerizable compound can be polymerized by light or heat with no or a very small amount of polymerization initiator added, and no or a very low effect of impurities originating from the photopolymerization initiator; thus, good reliability and productivity can both be achieved. In addition, the use of the polymerizable compound results in high reactivity, thereby providing the liquid crystal display device having an improved stability of the pretilt angle.

The polymerizable composition and polymerizable compound-containing liquid crystal composition of the present invention also have good storage stability, in which the storage stability is evaluated on the basis of, for example, the precipitation or separation of crystals during storage.

### DESCRIPTION OF EMBODIMENTS

A polymerizable compound according to a first embodiment of the present invention is represented by general formula (I):

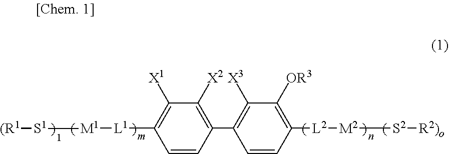

where in general formula (I), S¹ and S² are each independently at least one linking group selected from the group consisting of an alkylene group having 1 to 12 carbon atoms and a single bond, one —CH₂— group or two or more non-adjacent —CH₂— groups in the alkylene group are each optionally replaced with —O—, —COO—, —OCO—, or —OCOO—,

R¹ and R² are each independently a hydrogen atom or a group represented by any of formulae (R-1) to (R-15):

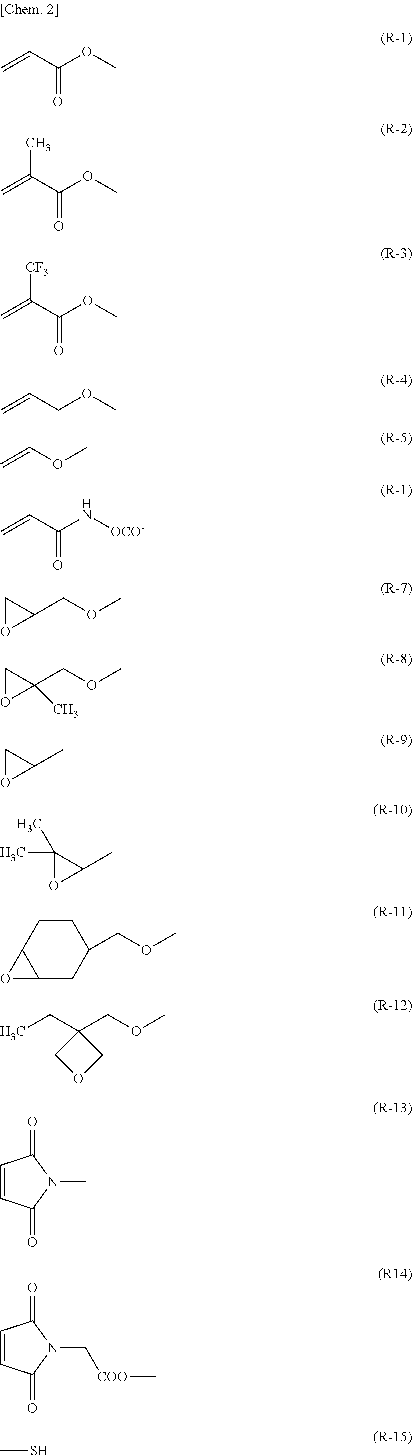

where R³ is an alkyl group having 1 to 4 carbon atoms,

L¹ is a single bond, —OCH₂—, —CH₂O—, —CO—, —C₂H₄—, —COO—, —OCO—, —OCOOCH₂—, —CH₂OCOO—, —OCH₂CH₂O—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —COOC₂H₄—, —OCOC₂H₄—, —C₂H₄OCO—, —CH₂OCO—, —COOCH₂—, —OCOCH₂—, —CH═CH—, —CF═CF—, —CF═CH—, —CH═CF—, —CF₂O—, —OCF₂—, —CF₂CH₂—, —CH₂CF₂—, —CF₂CF₂—, or —C≡C—, L² is —C₄H₈—, —OCH₂CH₂O—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —COOC₂H₄—, —OCOC₂H₄—, or —C₂H₄OCO— (where in the formulae, each R^{a} is independently a hydrogen atom or an alkyl group having 1 to 4 carbon atoms),

M¹ and M² are each independently a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a 1,3-dioxane-2,5-diyl group, a 1,3,5-benzenetriyl group, a 1,3,4-benzenetriyl group, or a 1,3,4,5-benzenetetrayl group, M¹ and M² are each independently optionally replaced with an alkyl group, a halogenated alkyl group, an alkoxy group, a halogenated alkoxy group, a halogen, a cyano group, or a nitro group,

X¹, X², and X³ are each independently a hydrogen atom, an alkyl group having 1 to 5 carbon atoms, a halogenated alkyl group having 1 to 5 carbon atoms, an alkoxy group having 1 to 5 carbon atoms, a halogenated alkoxy group having 1 to 5 carbon atoms, a halogen atom, a cyano group, or a nitro group,

m and n are each independently an integer of 0 or 1, and l and o are each independently an integer of 1 or 2).

The polymerizable compound of the present invention has the chemical structure represented by general formula (I). This results in an ultraviolet absorption band extending to longer wavelengths, higher curability, and improved solubility in a liquid crystal composition.

In general formula (I) according to the present invention, S¹ and S² are each more preferably an alkylene group having 1 to 12 carbon atoms or a single bond, more preferably an alkylene group having 1 to 6 carbon atoms or a single bond, particularly preferably a single bond. A polymer formed from the polymerizable compound has a rigid structure that does not change. Thus, the polymer suppresses a change in pretilt angle and is optimally used for PSA and PSVA liquid crystal display devices.

In general formula (I) according to the present invention, R¹ and R² are each independently a polymerizable group. Specific examples of the polymerizable group include structures described below.

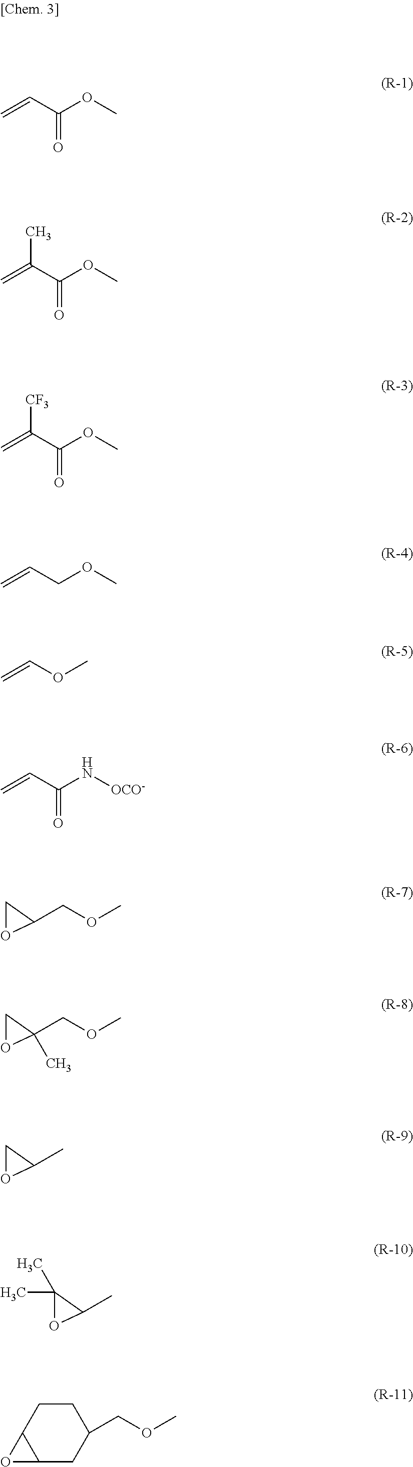

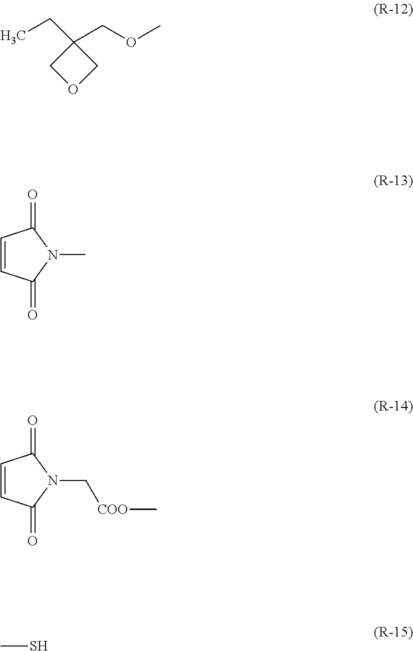

These polymerizable groups are cured by radical polymerization, radical addition polymerization, cationic polymerization, and anionic polymerization. In particular, in the case of performing ultraviolet polymerization, preferably used are formulae (R-1), (R-2), (R-4), (R-5), (R-7), (R-11), (R-13), and (R-15). More preferably used are formulae (R-1), (R-2), (R-7), (R-11), and (R-13). More preferably used are formulae (R-1) and (R-2).

In general formula (I) according to the present invention, R³ is an alkyl group having 1 to 4 carbon atoms, particularly preferably 1 to 2 carbon atoms. A larger number of carbon atoms results in a bulkier substituent, easily causing decreases in polymerization rate and the degree of polymerization. Thus, R³ is particularly preferably a methyl group.

Like OR³ in general formula (I) according to the present invention, the substitution of an alkoxy group provides the effect of allowing an absorption edge to extend to longer wavelengths. Like OR³ in general formula (I), in the case where an alkoxy group is attached toward the outside of the biphenyl backbone, the absorption shifts to longer wavelengths, compared with the case where the alkoxy group is attached toward the inside of the biphenyl backbone; thus, the polymerizable compound can be polymerized for a short UV irradiation time or at low irradiation energy.

In general formula (I) according to the present invention, L¹ is a single bond, —OCH₂—, —CH₂O—, —CO—, —C₂H₄—, —COO—, —OCO—, —OCOOCH₂—, —CH₂OCOO—, —OCH₂CH₂O—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —COOC₂H₄—, —OCOC₂H₄—, —C₂H₄OCO—, —CH₂OCO—, —COOCH₂—, —OCOCH₂—, —CH═CH—, —CF═CF—, —CF═CH—, —CH═CF—, —CF₂O—, —OCF₂—, —CF₂CH₂—, —CH₂CF₂—, —CF₂CF₂—, or —C≡C— (where in the formulae, each R^{a} is independently a hydrogen atom or an alkyl group having 1 to 4 carbon atoms), preferably a single bond, —OCH₂—, —CH₂O—, —CO—, —C₂H₄—, —COO—, —OCO—, —OCH₂CH₂O—, —CH═CR^{a}—COO—, —CH═CR^{a}—OCO—, —COO—CR^{a}═CH—, —OCO—CR^{a}═CH—, —COOC₂H₄—, —OCOC₂H₄—, or —C₂H₄OCO—, more preferably a single bond, —OCH₂—, —CH₂O—, —CO—, —C₂H₄—, —CF₂O—, —OCF₂—, or —C≡C—. In the case where a compound is used in which L¹ is a single bond, —OCH₂—, —CH₂O—, —CO—, —C₂H₄—, —CF₂O—, —OCF₂—, or —C≡C—, a film formed from a polymerizable liquid crystal composition containing the compound (composition used for an optically anisotropic body) is advantageously rigid.

In general formula (I) according to the present invention, L² is —C₄H₈—, —OCH₂CH₂O—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —COOC₂H₄—, —OCOC₂H₄—, or —C₂H₄OCO— (where in the formulae, each R^{a} is independently a hydrogen atom or an alkyl group having 1 to 4 carbon atoms), preferably —C₄H₈—, —OCH₂CH₂O—, —CH═CR^{a}—COO—, —CH═CR^{a}—OCO—, —COO—CR^{a}═CH—, —OCO—CR^{a}═CH—, —COOC₂H₄—, —OCOC₂H₄—, or —C₂H₄OCO—, more preferably —C₄H₈— or OCH₂CH₂O—. A compound in which L² is —C₄H₈— or OCH₂CH₂O— advantageously has good solubility.

In general formula (I) according to the present invention, M¹ and M² are each independently optionally unsubstituted or, if necessary, substituted with an alkyl group having 1 to 5 carbon atoms, a halogenated alkyl group having 1 to 5 carbon atoms, an alkoxy group having 1 to 5 carbon atoms, a halogenated alkoxy group having 1 to 5 carbon atoms, a hydrogen atom, a cyano group, or a nitro group. M¹ and M² are each independently a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a 1,3-dioxane-2,5-diyl group, a 1,3,5-benzenetriyl group, a 1,3,4-benzenetriyl group, or a 1,3,4,5-benzenetetrayl group, preferably a 1,4-phenylene group, a 1,4-cyclohexylene group, a pyridine-2,5-diyl group, a naphthalene-2,6-diyl group, a 1,3-dioxane-2,5-diyl group, a 1,3,5-benzenetriyl group, a 1,3,4-benzenetriyl group, or a 1,3,4,5-benzenetetrayl group, more preferably a 1,4-phenylene group, a pyridine-2,5-diyl group, a naphthalene-2,6-diyl group, a 1,3-dioxane-2,5-diyl group, a 1,3,5-benzenetriyl group, a 1,3,4-benzenetriyl group, or a 1,3,4,5-benzenetetrayl group, even more preferably a 1,4-phenylene group, a 1,3,5-benzenetriyl group, a 1,3,4-benzenetriyl group, or a naphthalene-2,6-diyl group.

In the case where all the ring structures of the compound represented by general formula (I) according to the present invention are aromatic, the compound has good UV reactivity.

In general formula (I) according to the present invention, X¹, X², and X³ are each independently preferably a hydrogen atom, an alkyl group having 1 to 3 carbon atoms, an alkyl group having 1 to 3 carbon atoms, a halogenated alkyl group having 1 to 3 carbon atoms, an alkoxy group having 1 to 3 carbon atoms, a halogenated alkoxy group having 1 to 3 carbon atoms, or a halogen atom, more preferably a hydrogen atom, a methyl group, a methoxy group, a trifluoromethyl group, a trifluoromethoxy group, a fluorine atom, or a chlorine atom. In general formula (I) according to the present invention, in the case where m is 1 and where L¹ is a single bond, —OCH₂—, —CH₂O—, —CO—, —C₂H₄—, —CF₂O—, —OCF₂—, or —C≡C—, M¹ and M² are each independently preferably a 1,4-cyclohexylene group, a 1,4-phenylene group, a naphthalene-2,6-diyl group, a 1,3,5-benzenetriyl group, or a 1,3,4-benzenetriyl group. A film formed from a polymerizable liquid crystal composition (composition used for an optically anisotropic body) containing a compound that satisfies the foregoing requirements can be rigid.

In general formula (I) according to the present invention, in the case where m+n is 1, M¹ or M² is preferably a 1,3,5-benzenetriyl group or a 1,3,4-benzenetriyl group. Preferably, M² is a 1,4-phenylene group, a 1,3,5-benzenetriyl group, or a 1,3,4-benzenetriyl group, and n is 1. More preferably, M² is a 1,3,5-benzenetriyl group or a 1,3,4-benzenetriyl group, n is 1, and o is 2.

A liquid crystal composition (liquid crystal composition for operation (for example, for PSA)) containing a compound that satisfies the foregoing requirements has the effect of providing good storage stability or UV reactivity.

In general formula (I) according to the present invention, m and n are each independently preferably an integer of 0 or 1. Preferably, m and n are each independently 0.

In general formula (I) according to the present invention, preferably, m is 0, and n is an integer of 0 or 1. A liquid crystal composition (a driving liquid crystal composition (for example, for PSA)) containing a compound that satisfies the foregoing requirements has the effect of providing good storage stability.

In general formula (I) according to the present invention, m+n is preferably an integer of 0 to 2, more preferably an integer of 0 or 1, even more preferably 0.

In general formula (I) according to the present invention, l and o are each independently 1 or 2. Preferably, l and o are each independently 1.

In general formula (I) according to the present invention, l+o is preferably an integer of 2 to 4, more preferably an integer of 2 or 3, particularly preferably 2.

The compound represented by general formula (I) according to a preferred embodiment of the present invention is a polymerizable compound in which m+n is 0 or 1. The compound according to a more preferred embodiment is a polymerizable compound in which m and n are each 0. The compound represented by general formula (I) according to another embodiment is preferably a polymerizable compound in which l+n is 1, more preferably a polymerizable compound in which m is 0 and in which l and n is 1.

The addition of the polymerizable compound having the chemical structure to a liquid crystal composition or the like can form a rigid polymer having good compatibility with another non-polymerizable liquid crystal compound and high crosslink density, thus strongly holding an alignment-regulating force acting on a coexisting liquid crystal compound. The liquid crystal composition containing the polymerizable compound contains at least one or more alkoxy group. Thus, a rapid polymerization reaction can occur by efficient absorption of light energy.

Specifically, the compound represented by general formula (I) according to the present invention is preferably a compound represented by any of general formulae (I-1) to (I-29) illustrated below.

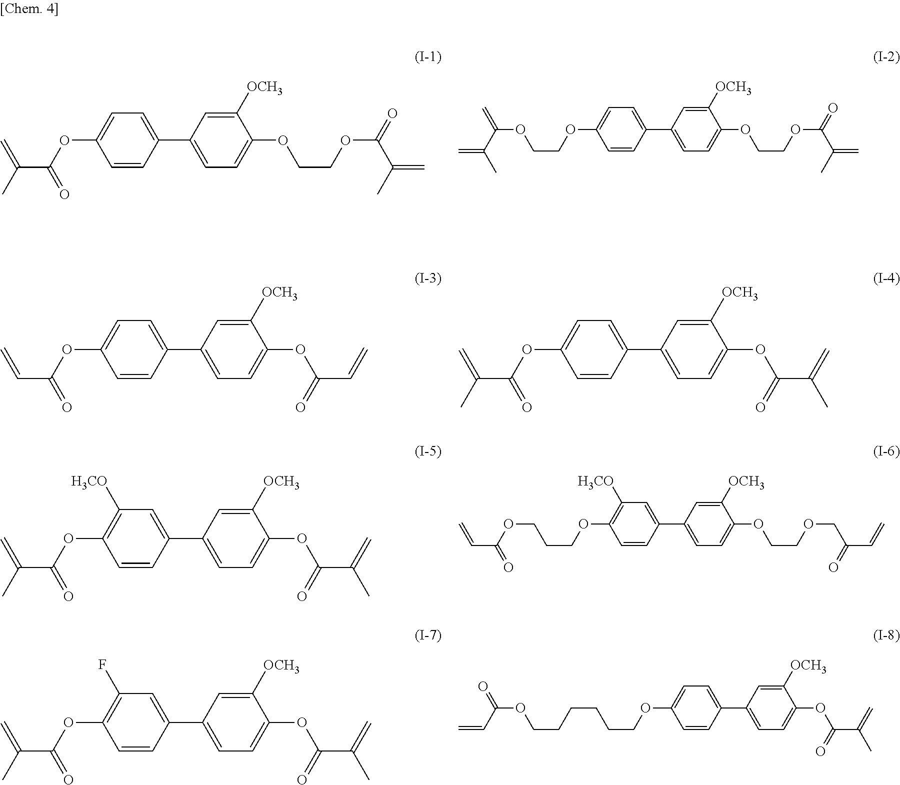

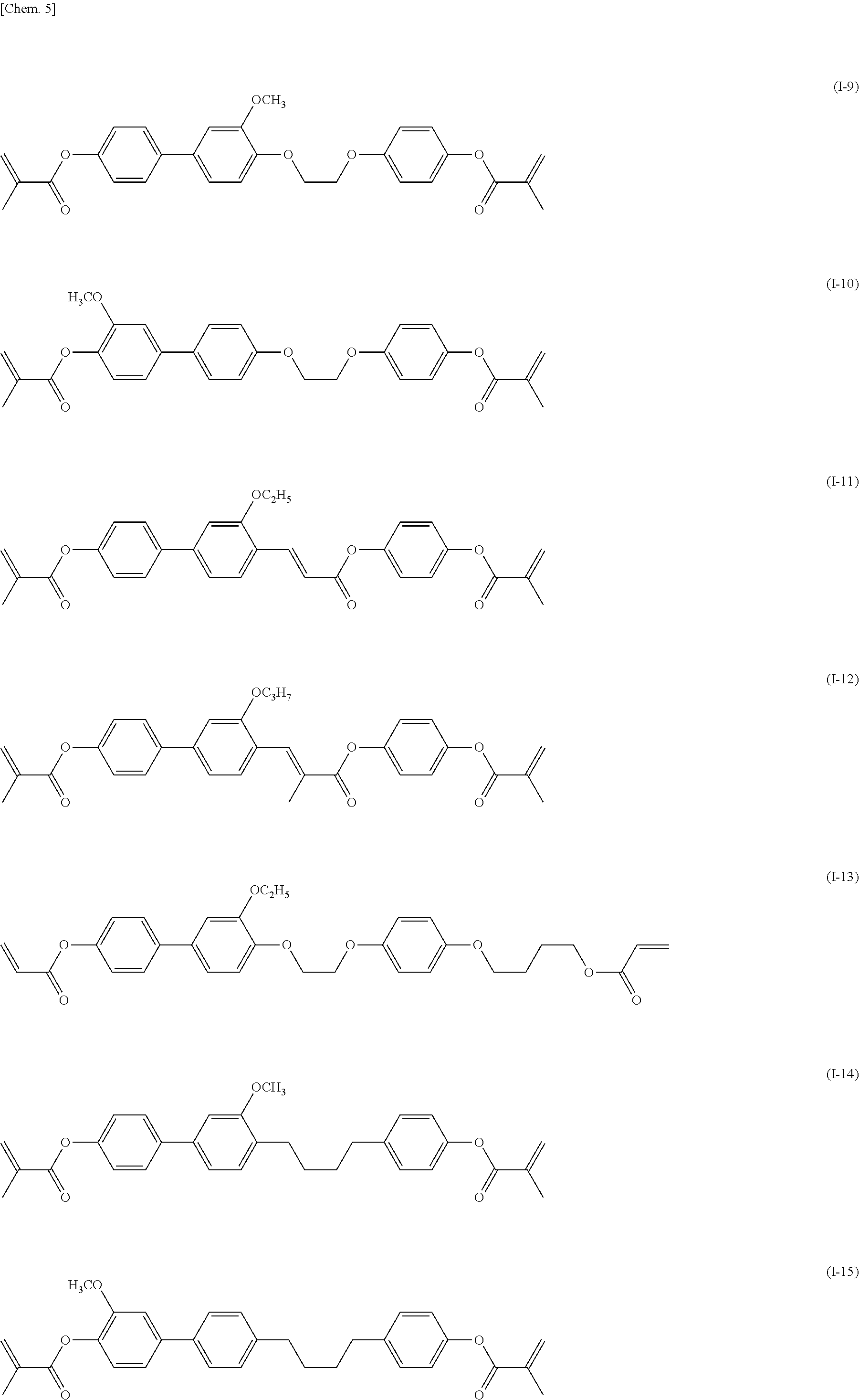

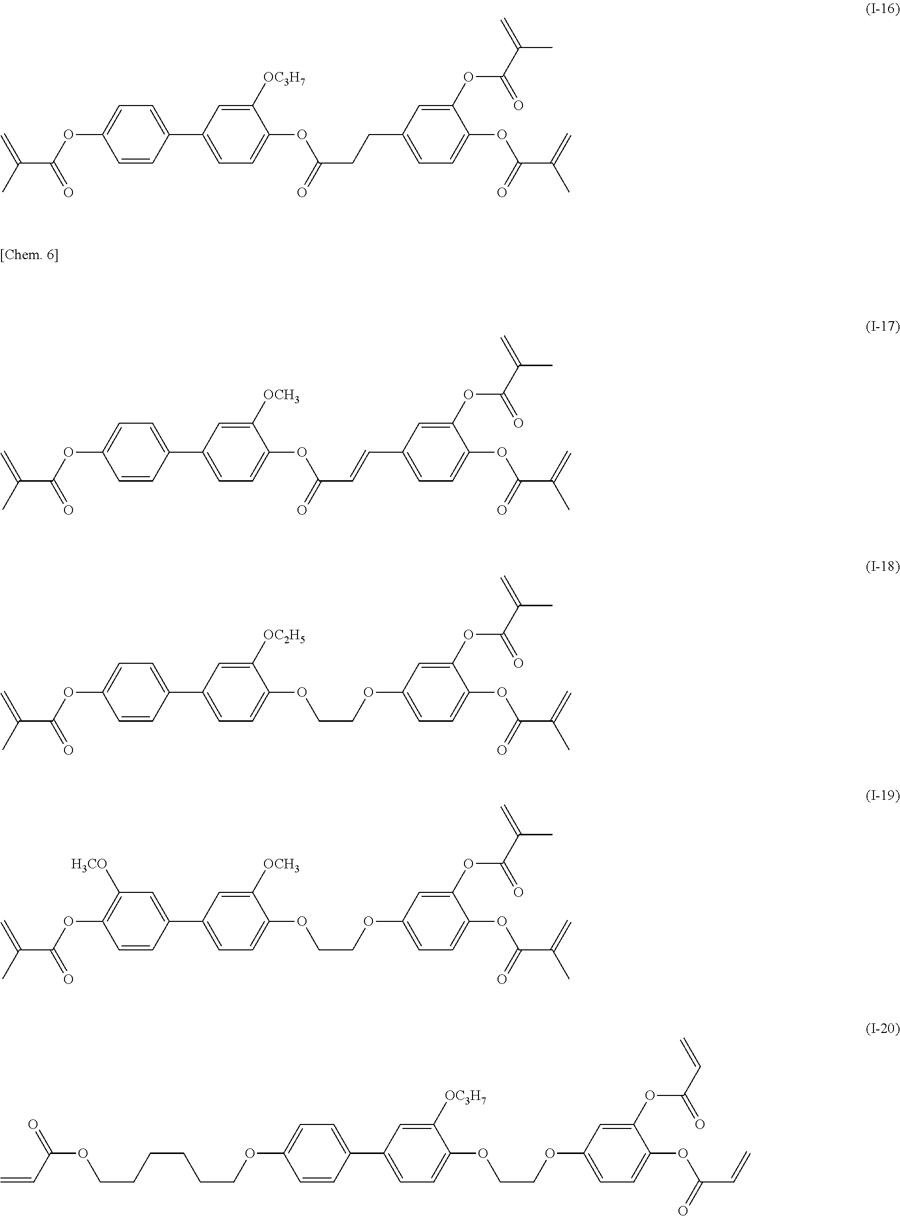

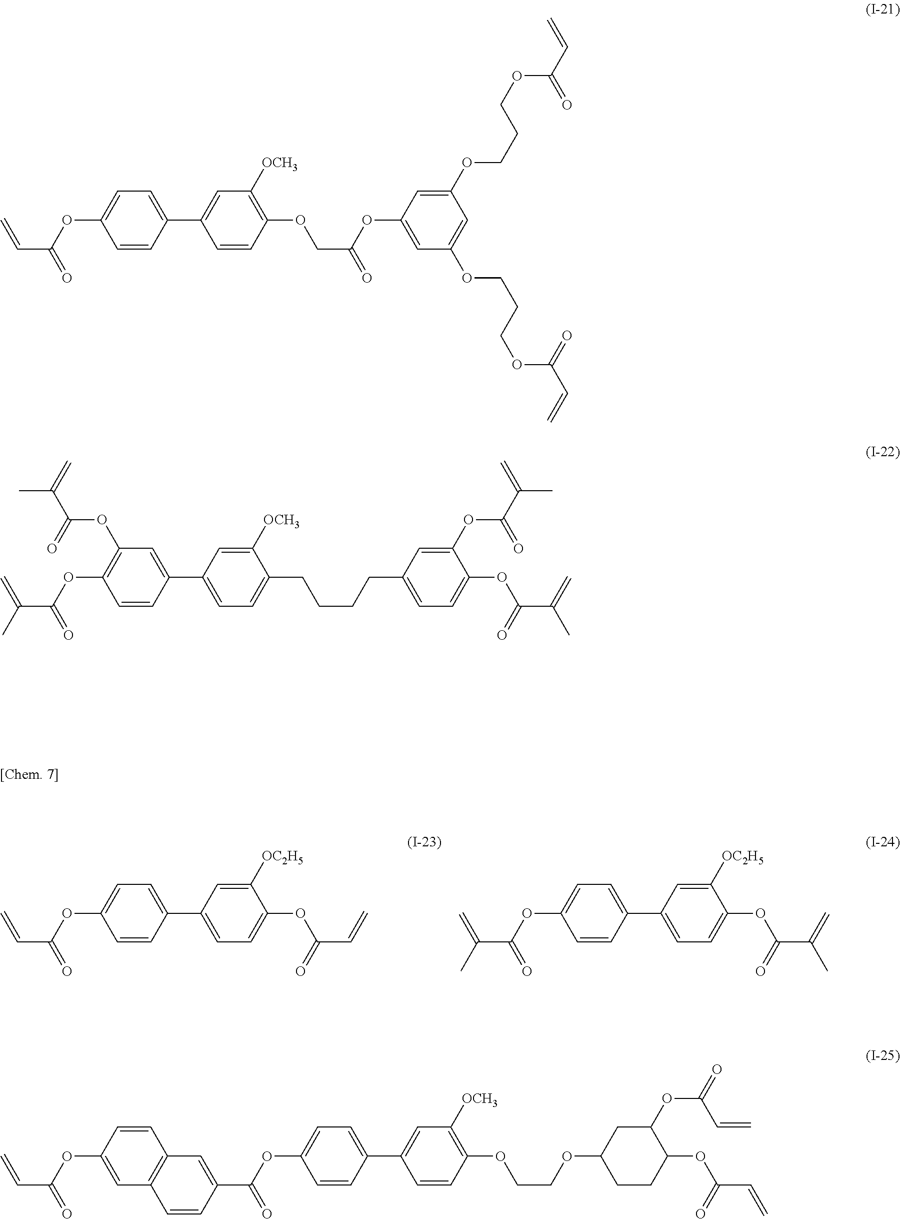

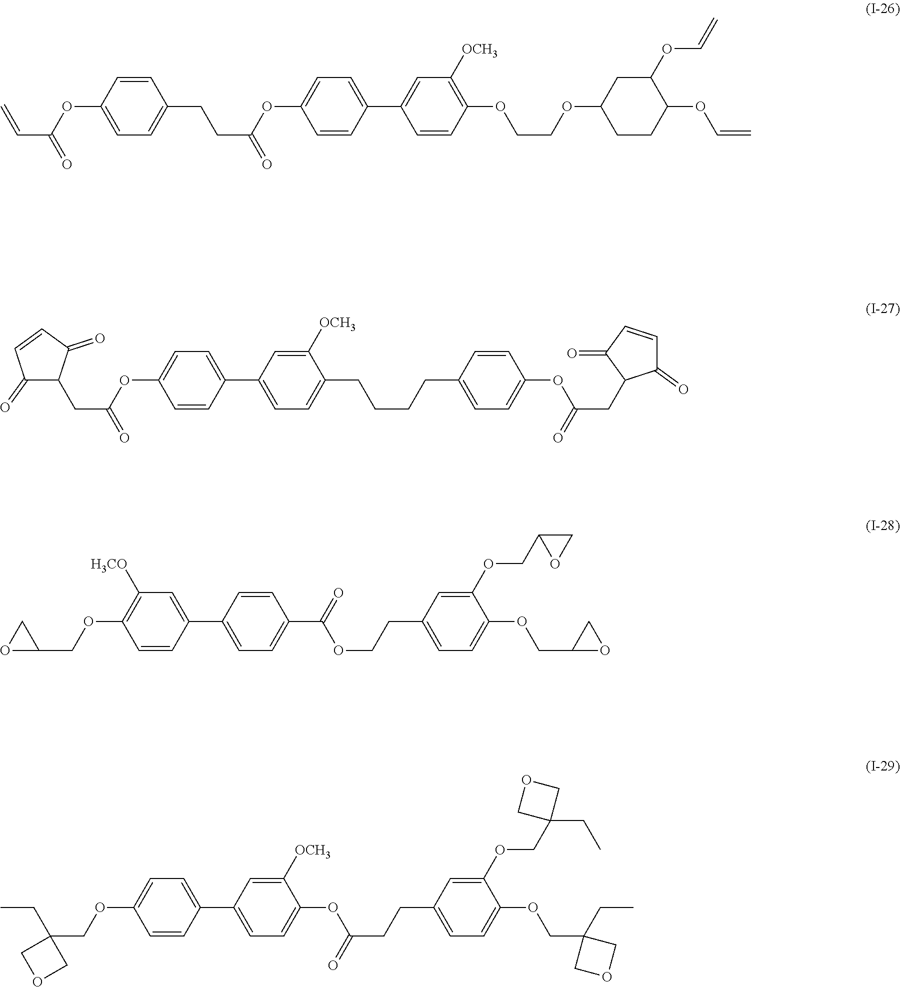

The polymerizable compound of the present invention can be synthesized by a synthesis method described below.

### (Production Process 1) Production of Compound Represented by General Formula (I-9)

First, 4′-benzyloxy-4-hydroxy-3-methoxybiphenyl and ethylene glycol mono-tert-butyl ether are subjected to the Mitsunobu reaction with triphenylphosphine and diisopropyl azodicarboxylate to give biphenol derivative (S-1). The derivative is subjected to catalytic hydrogen reduction with palladium on carbon and then an esterification reaction with methacryloyl chloride to give methacrylate derivative (S-2). The tert-butyl group is eliminated with trifluoroacetic acid and converted into ethanol to give methacrylate derivative (S-3).

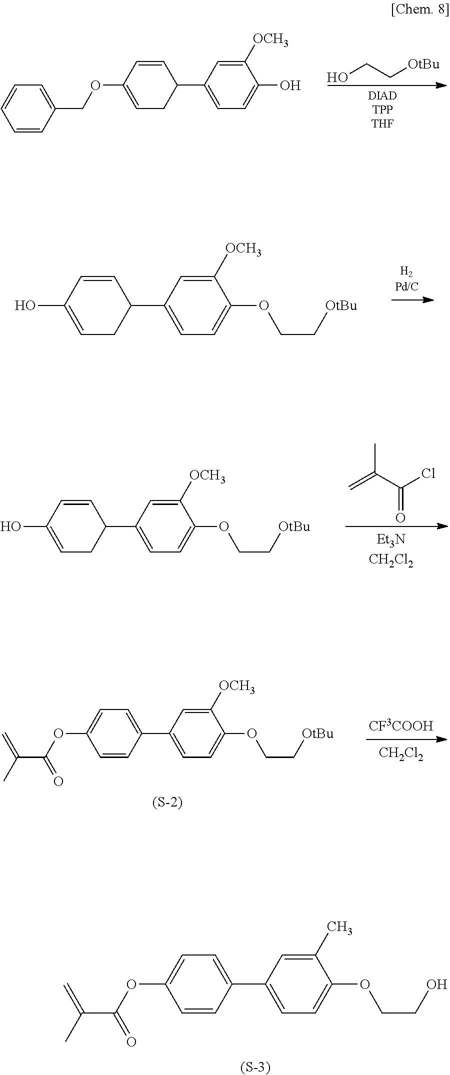

Then methacrylate derivative (S-3) and 4-methacryloyloxyphenol are subjected to the Mitsunobu reaction with triphenylphosphine and diisopropyl azodicarboxylate to give target compound (I-9).

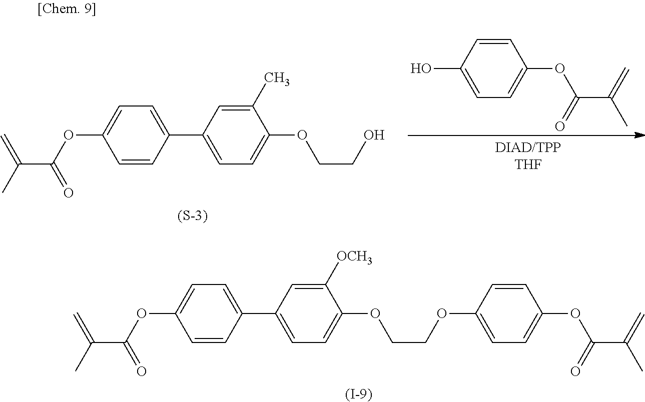 [SMILES: C=C(C)C(=O)Oc1ccc(-c2ccc(OCCO)c(C)c2)cc1 ; C=C(C)C(=O)Oc1ccc(O)cc1 ; "(S-3)" ; C=C(C)C(=O)Oc1ccc(OCCOc2ccc(-c3ccc(OC(=O)C(=C)C)cc3)cc2OC)cc1 ; "(I-9)"]

### (Production Process 2) Production of Compound Represented by General Formula (I-12)

First, 4-bromo-4′-oxytetrahydroxypyranyl-3-propoxybiphenyl and tert-butyl methacrylate are subjected to the Heck reaction to give biphenyl derivative (S-4). The tetrahydropyranyl group is eliminated with a hydrochloric acid/tetrahydrofuran solution. The resulting compound is subjected to an esterification reaction with methacrylic acid to give methacrylate derivative (S-5). The tert-butyl group is eliminated with formic acid/dichloromethane. The resulting compound is esterified with 4-methacryloyloxyphenol to give target compound (I-12).

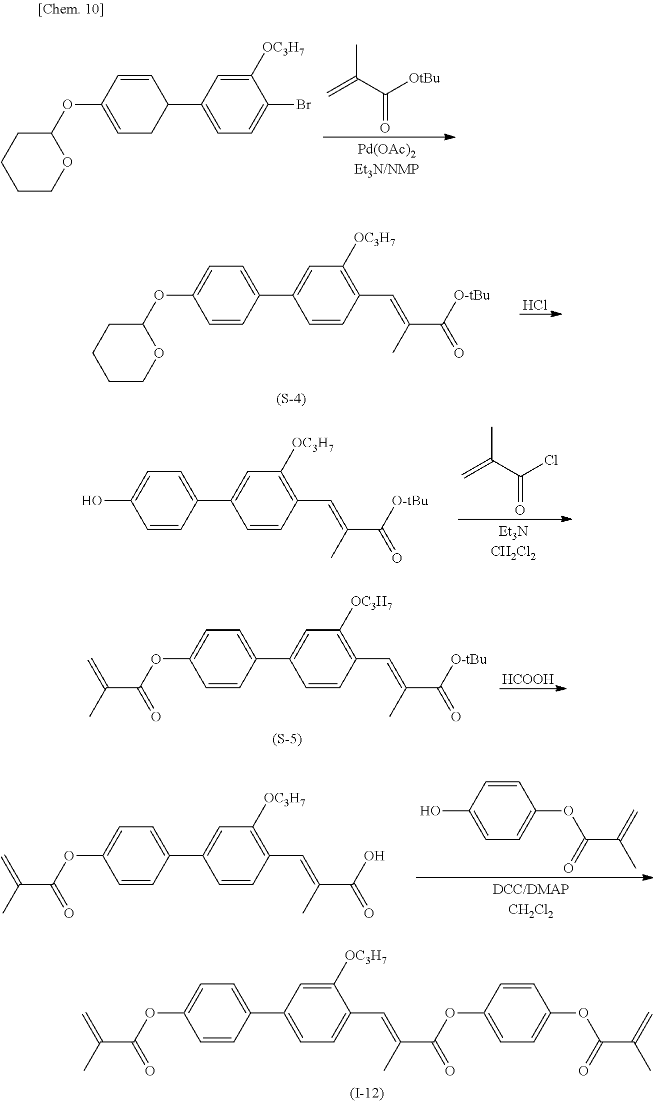

### (Production Process 3) Production of Compound Represented by General Formula (I-20)

First, 4′-benzyloxy-4-hydroxy-3-propoxybiphenyl and ethylene glycol mono-tert-butyl ether are subjected to the Mitsunobu reaction with triphenylphosphine and diisopropyl azodicarboxylate to give biphenyl derivative (S-6). The derivative is subjected to catalytic hydrogen reduction with palladium on carbon and then an etherification reaction with 6-chlorohexyl acrylate to give acrylate derivative (S-7).

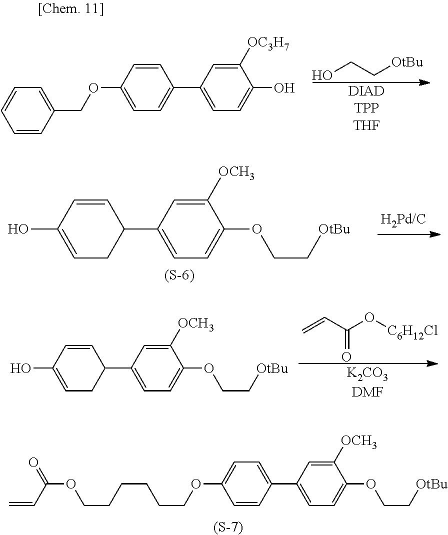

The tert-butyl group is eliminated with trifluoroacetic acid and converted into ethanol to give methacrylate derivative (S-8). The derivative and 3,4-diacryloxyphenol are subjected to the Mitsunobu reaction with triphenylphosphine and diisopropyl azodicarboxylate to give target compound (I-20).

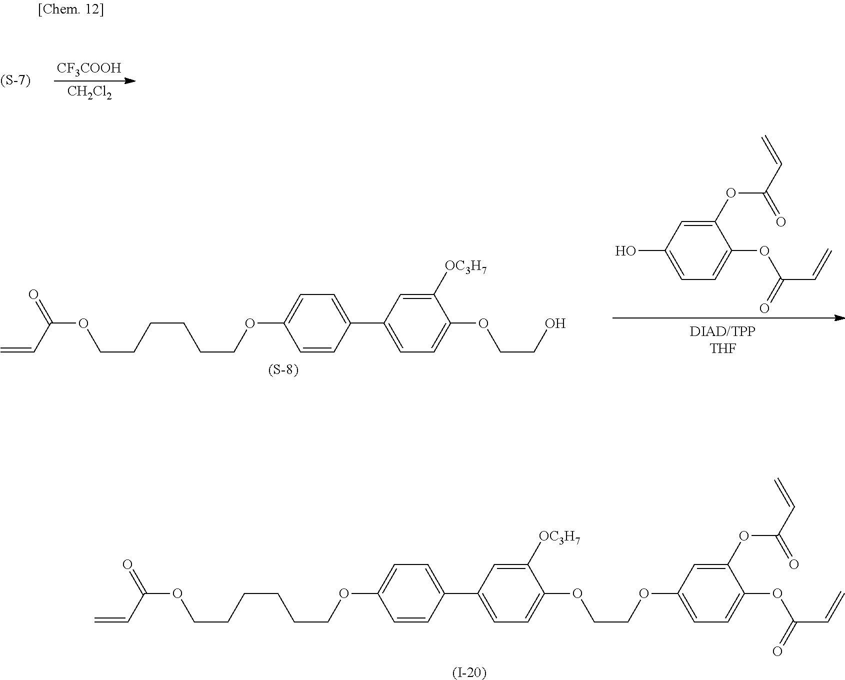

### (Production Process 4) Production of Compound Represented by General Formula (I-27)

First, 4-{(4′-benzyloxy)-3-methoxy-(1,1′-biphenyl)-4-yl}butanal is reacted with 4-benzyloxyphenylmagnesium bromide to form biphenyl derivative (S-9). The derivative is subjected to a dehydration reaction with p-toluenesulfonic acid to give alkene compound (S-10). The resulting compound is subjected to catalytic hydrogen reduction with palladium on carbon to reduce the benzyl group and the alkene moiety to give hydroxybiphenyl derivative (S-11).

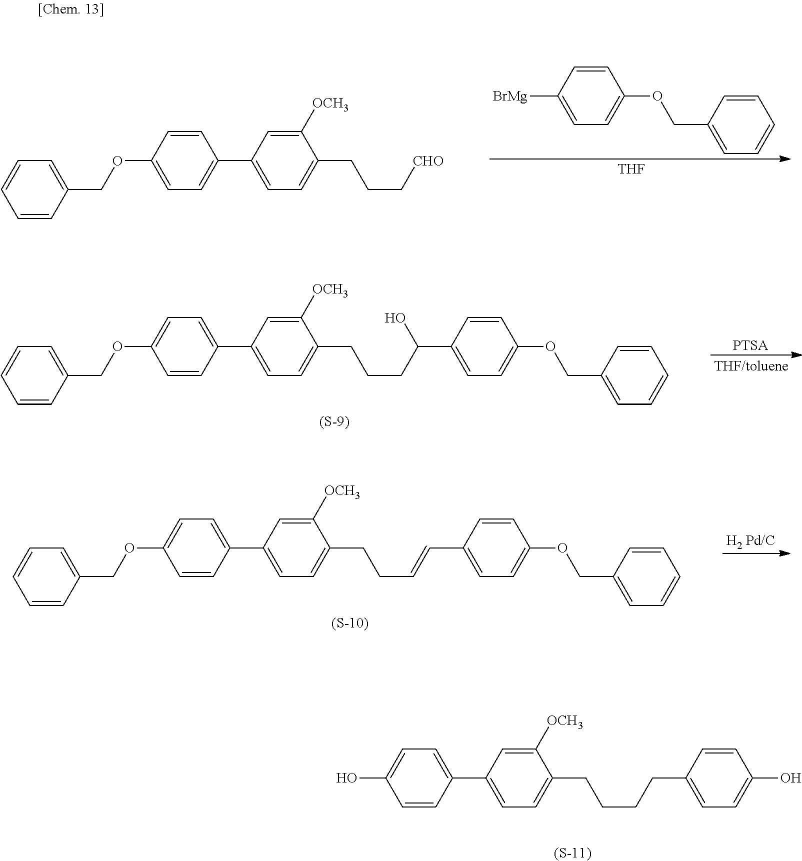

Then hydroxybiphenyl derivative (S-11) is esterified with maleimidoacetic acid to give target compound (I-27).

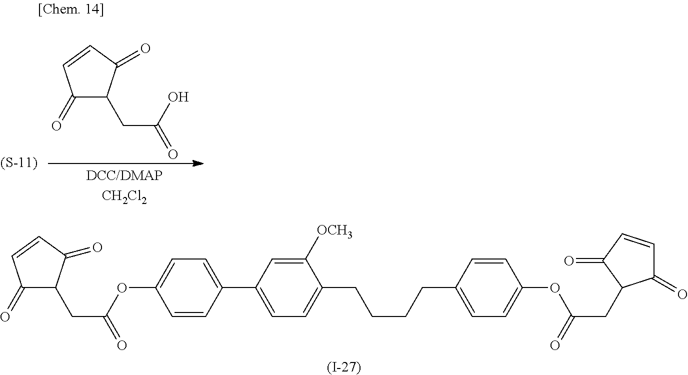 [SMILES: O=C(O)CC1C(=O)C=CC1=O ; "(S-11)" ; COc1cc(-c2ccc(OC(=O)CC3C(=O)C=CC3=O)cc2)ccc1CCCCc1ccc(OC(=O)CC2C(=O)C=CC2=O)cc1 ; "(I-27)"]

In the present invention, a composition containing the polymerizable compound represented by general formula (I), which is an essential component, and a polymerizable compound represented by general formula (II), which is optionally added, is referred to as a polymerizable composition. A composition containing the polymerizable compound or the polymerizable composition and at least one or more liquid crystal compounds is referred to as a polymerizable compound-containing liquid crystal composition. The polymerizable compound according to the present invention is preferably a liquid crystal compound.

The polymerizable composition and the polymerizable compound-containing liquid crystal composition of the present invention may further contain another polymerizable compound in any range in addition to at least one or more polymerizable compounds of the present invention. Specific examples of a polymerizable compound other than that of the present invention are not particularly limited. As a polymerizable liquid crystal compound used in combination, a polymerizable compound having an acryloyloxy group (R-1) or a methacryloyloxy group (R-2) is preferred. A polymerizable compound having two or more polymerizable functional groups in its molecule is more preferred.

Specific examples of the polymerizable (liquid crystal) compound used in combination include compounds represented by general formula (II):

[Chem. 15]

R¹¹—S¹¹-L¹¹-M¹¹L¹²-M¹²ₗ_{¹¹}A¹¹ (II)

(where in the formula, R¹¹ is a polymerizable group, S¹¹ is independently a single bond or an alkylene group having 1 to 12 carbon atoms, a carbon atom of one or more —CH₂— groups thereof is optionally replaced with an oxygen atom, —COO—, —OCO—, or —OCOO— as long as oxygen atoms are not directly bonded together, L¹¹ and L¹² are each independently a single bond, —O—, —S—, —OCH₂—, —CH₂O—, —CO—, —COO—, —OCO—, —OCOOCH₂—, —CH₂OCOO—, —CO—NR¹³—, —NR¹³—CO—, —CH═N—, —SCH₂—, —CH₂S—, —CH═CH—COO—, —OOC—CH═CH—, —COOC₂H₄—, —OCOC₂H₄—, —C₂H₄OCO—, —C₂H₄COO—, —OCOCH₂—, —CH₂COO—, —CH═CH—, —C₂H₄—, —CF═CH—, —CH═CF—, —CF₂—, —CF₂O—, —OCF₂—, —CF₂CH₂—, —CH₂CF₂—, —CF₂CF₂—, or —C≡C— (where in the formulae, each R¹³ is an alkyl group having 1 to 4 carbon atoms), M¹¹ and M¹² are each independently a 1,4-phenylene group, a 1,4-cyclohexylene group, a pyridine-2,5-diyl group, a pyrimidine-2,5-diyl group, a naphthalene-2,6-diyl group, a tetrahydronaphthalene-2,6-diyl group, or a 1,3-dioxane-2,5-diyl group, M¹ and M¹ are each independently optionally unsubstituted or substituted with an alkyl group, a halogenated alkyl group, an alkoxy group, a halogenated alkoxy group, a halogen group, a cyano group, or a nitro group, l¹¹ is 0, 1, 2, or 3, and in the case where l¹¹ is 2 or 3, two or three L¹² groups may be the same or different, and two or three M¹² groups may be the same or different).

In the compound represented by general formula (II), L¹¹ and L¹² are each independently preferably a single bond, —O—, —COO—, or —OCO—, and M¹¹ and M¹² are each independently preferably a 1,4-phenylene group, a 1,4-cyclohexylene group, a pyridine-2,5-diyl group, a pyrimidine-2,5-diyl group, or a naphthalene-2,6-diyl group.

Specifically, the compound represented by general formula (II) is preferably a compound represented by any of general formulae (II-1) to (II-43):

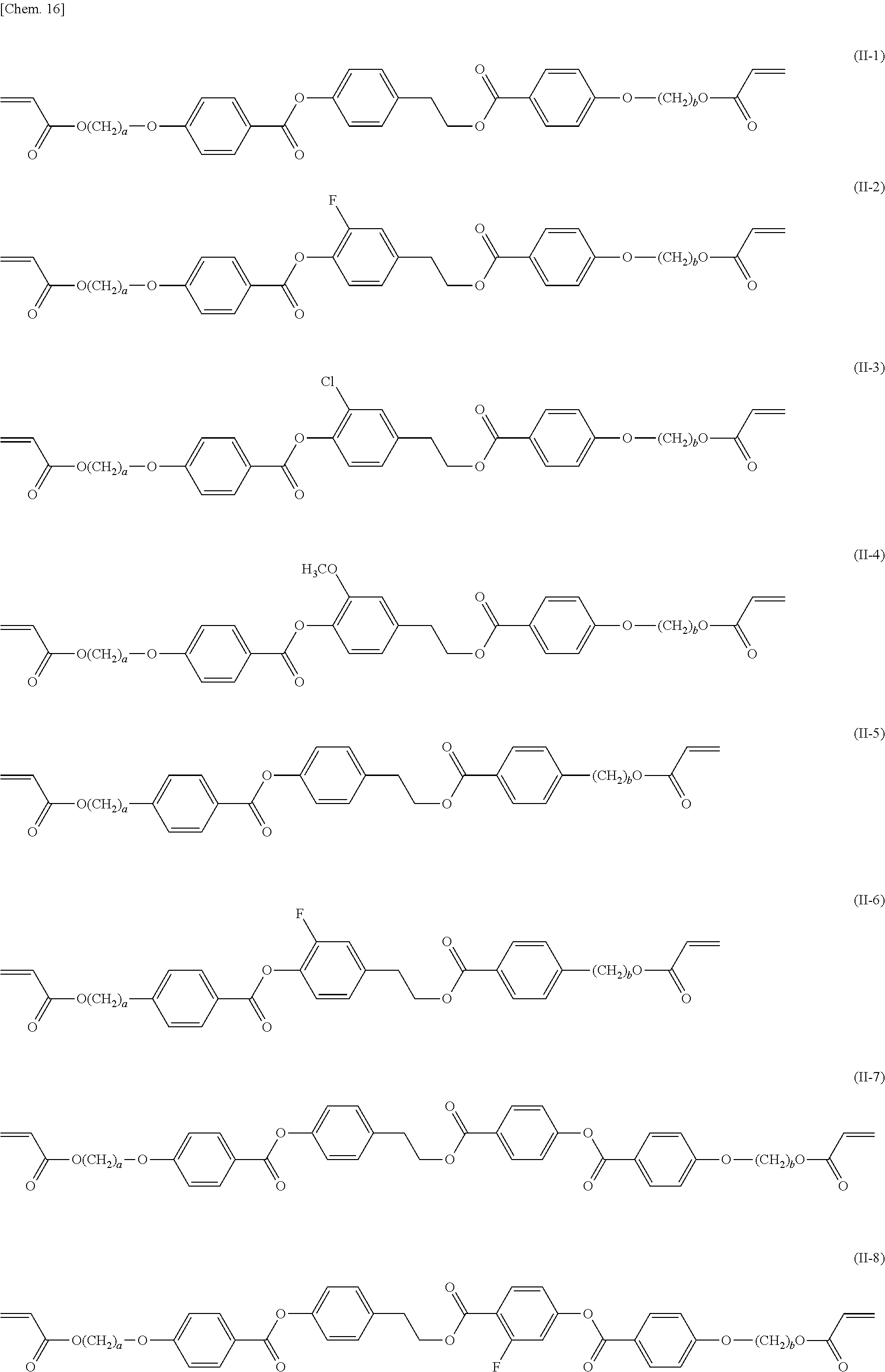

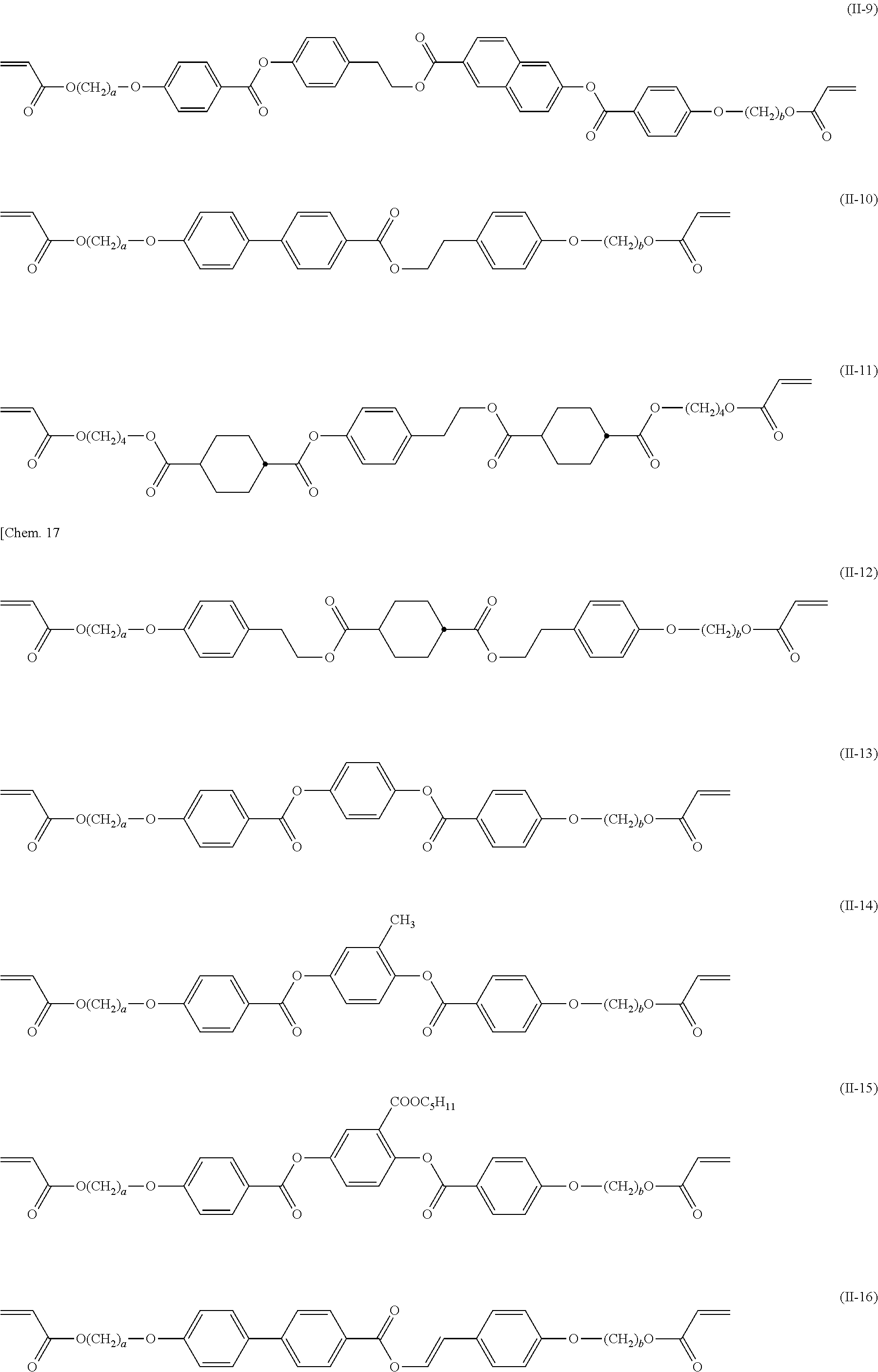

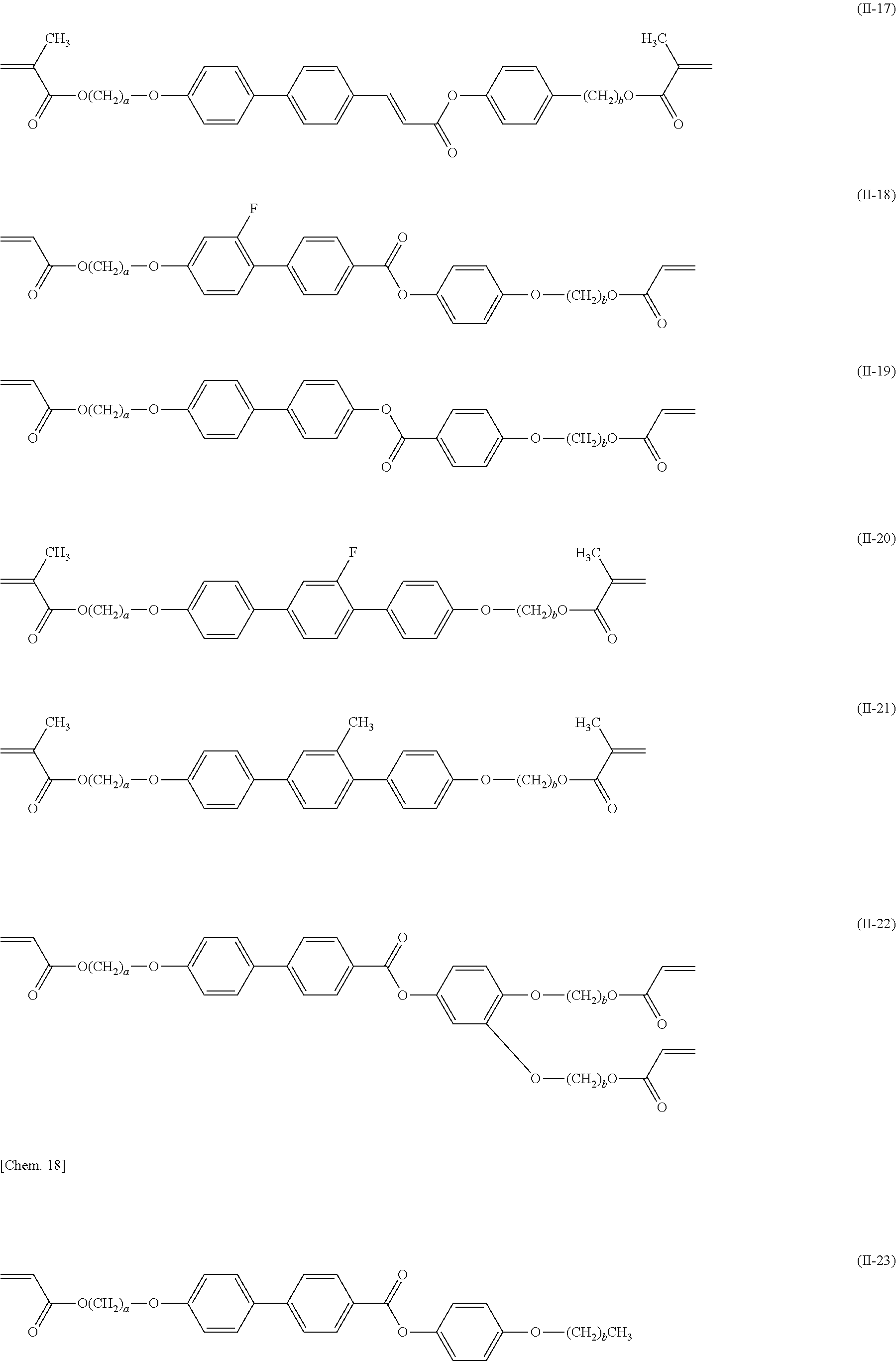

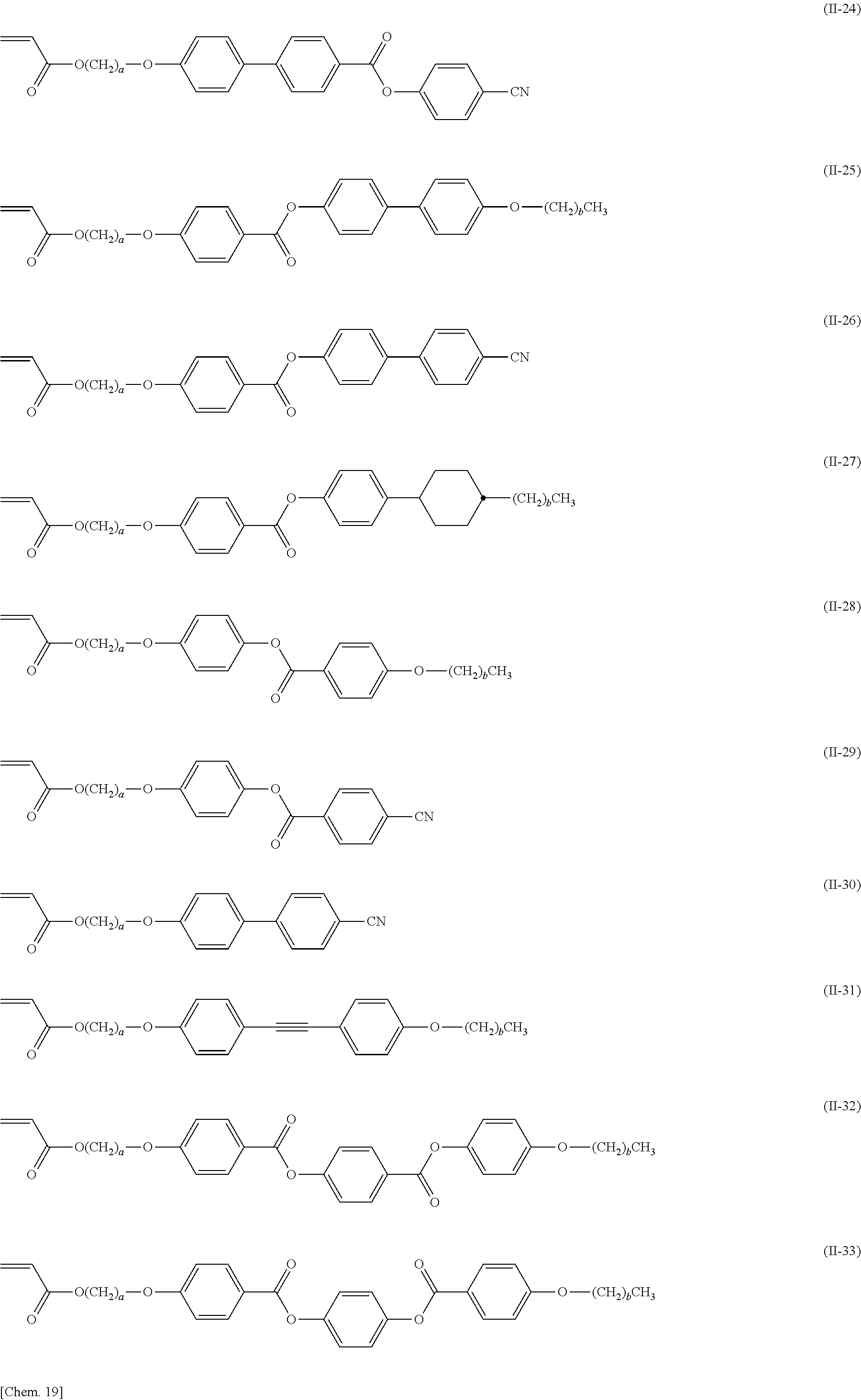

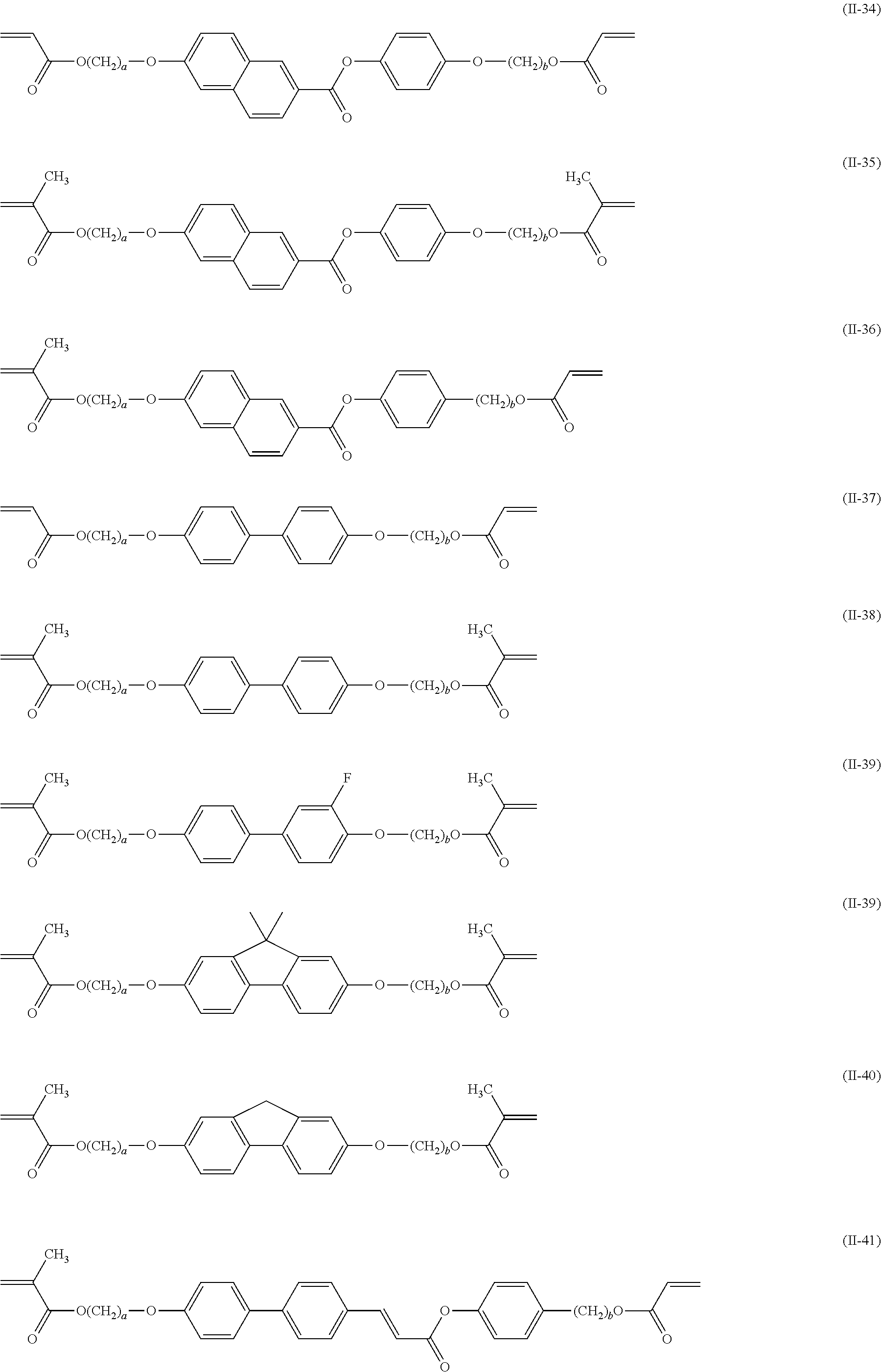

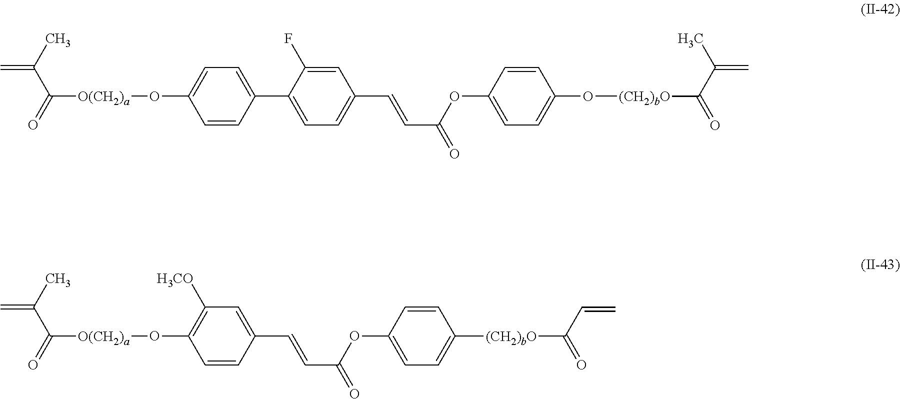

(where in each of the formulae, a and b are each an integer of 0 to 12, and in the case where a and/or b is 0 and where oxygen atoms are directly bonded together, one of the oxygen atoms is eliminated).

The polymerizable compound of the present invention is useful as a component of optical compensation films used for polarizers, retardation plates, and so forth, is also useful for polymer sustained alignment (PSA)-mode liquid crystal display devices and polymer stabilized vertical alignment (PSVA)-mode liquid crystal display devices, and can be used for Optically compensated birefringence (OCB)-LCDs and in-plane-switching liquid crystal display devices (IPS-LCDs). As operating modes of the liquid crystal display devices, active-matrix addressing and passive-matrix addressing can be used. The polymerizable compound of the present invention is useful for active-matrix addressed liquid crystal display devices (AM-LCDs), nematic liquid crystal display devices (TN-LCDs), and super-twisted nematic liquid crystal display devices (STN-LCDs) and particularly useful for AM-LCDs.

Examples of a non-polymerizable liquid crystal composition that can be used include known fluorine-containing nematic liquid crystal compositions having positive or negative dielectric anisotropy, tolan-containing nematic liquid crystal compositions having positive or negative dielectric anisotropy, cyano-containing nematic liquid crystal compositions having positive dielectric anisotropy, ferroelectric liquid crystal compositions, blue-phase liquid crystal compositions, cholesteric liquid crystal compositions. In the case where the liquid crystal composition of the present invention is a cholesteric liquid crystal, a chiral compound is usually added thereto. Specifically, the compound is represented by any of general formulae (IV-1) to (IV-7). The amount of the chiral compound added is preferably 0.5% to 30% by weight, more preferably 2% to 20% by weight with respect to the liquid crystal composition.

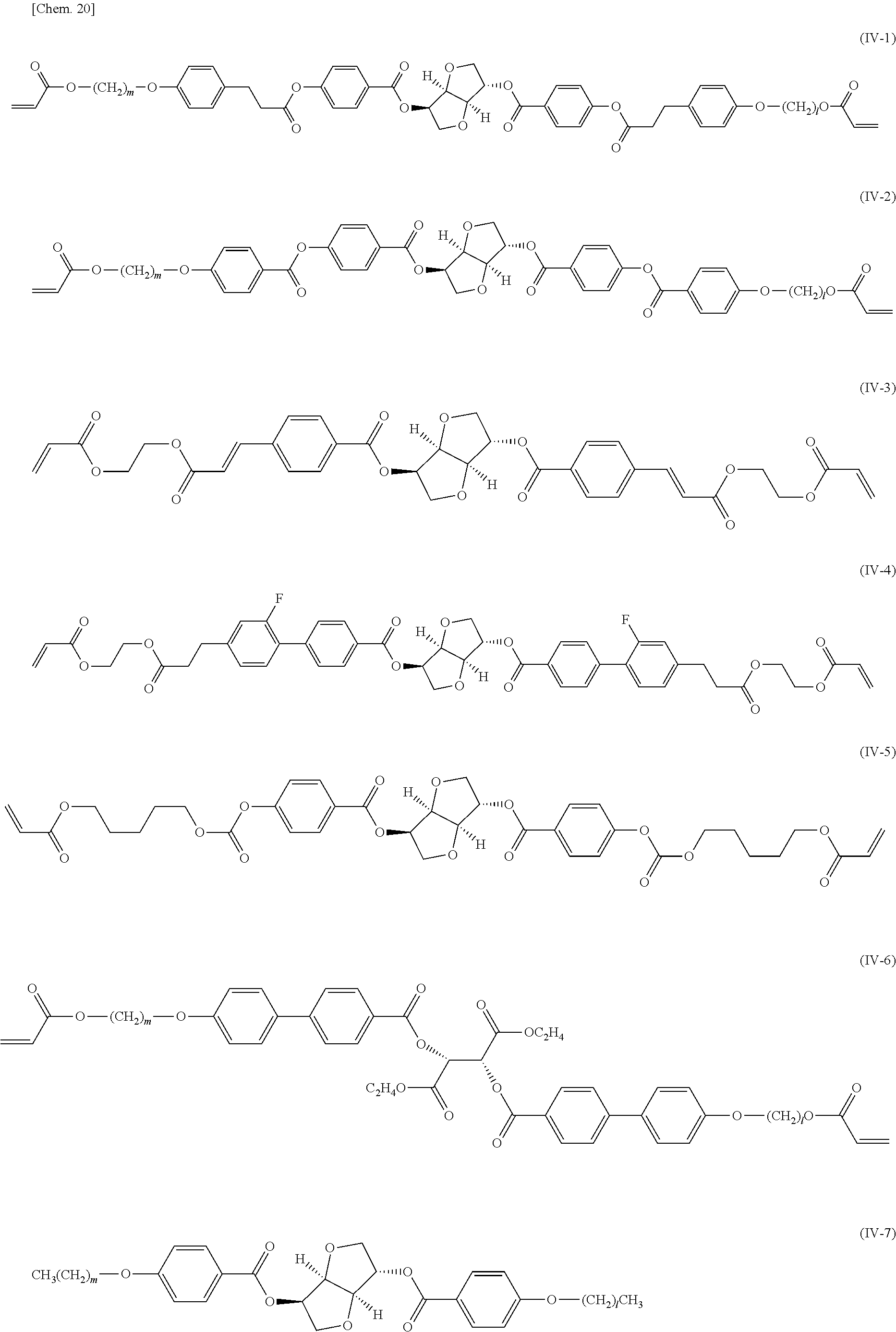

(In the formulae, m and l are each an integer of 0 to 12, and in the case where m and/or l is 0 and where oxygen atoms are directly bonded together, one of the oxygen atoms is eliminated).

In the case of PSA, PS-VA, PS-IPS, and PS-OCB liquid crystal compositions containing the polymerizable compound of the present invention, each of the liquid crystal compositions contains at least one polymerizable compound represented by general formula (I), preferably one to five polymerizable compounds, particularly preferably one to three polymerizable compounds. A low content of the polymerizable compound represented by general formula (I) results in low alignment-regulating force acting on a non-polymerizable liquid crystal compound. An excessively high content thereof results in an increase in energy required for polymerization to increase the amount of remaining unpolymerized polymerizable compound. Thus, the lower limit thereof is preferably 0.01% by mass, more preferably 0.03% by mass. The upper limit is preferably 5.0% by mass, more preferably 1.0% by mass.

A compound that does not exhibit liquid crystallinity may be added to the polymerizable (liquid crystal) composition of the present invention. As the compound, any of compounds usually recognized as polymer-forming monomers or polymer-forming oligomers in this technical field may be used without particular limitation. In the case where the polymerizable composition is required to exhibit a liquid crystalline phase, the amount of the compound added needs to be adjusted in such a manner that the polymerizable compound-containing liquid crystal composition exhibits liquid crystallinity after addition.

The polymerizable (liquid crystal) composition of the present invention contains conjugated biphenyl and phenylnaphthalene backbones, alone which t-electrons are highly delocalized, and thus can be polymerized by heat or light without adding a polymerization initiator; however, a photopolymerization initiator may be added thereto. The concentration of the photopolymerization initiator added is preferably 0.1% to 10% by mass, more preferably 0.2% to 10% by mass, particularly preferably 0.4% to 5% by mass. Examples of the photoinitiator include benzoin ethers, benzophenones, acetophenones, benzyl ketals, and acyl phosphine oxides.

A stabilizer may be added to the polymerizable (liquid crystal) composition of the present invention in order to improve the storage stability thereof. Examples of the stabilizer that can be used include hydroquinones, hydroquinone monoalkyl ethers, tertiary butyl catechols, pyrogallols, thiophenols, nitro compounds, β-naphthylamines, β-naphthols, and nitroso compounds. The amount of the stabilizer added is preferably 0.005% to 1% by mass, more preferably 0.02% to 0.5% by mass, particularly preferably 0.03% to 0.1% by mass with respect to the polymerizable composition.

In the case where the polymerizable (liquid crystal) composition of the present invention is used as a raw material for retardation films, polarizer films, and alignment films, or used for applications such as printing ink, paint, and protective films, examples of an additive that can be added include metals, metal complexes, dyes, pigments, solvents, coloring agents, fluorescent materials, phosphorescent materials, surfactants, leveling agents, thixotropic agents, gelling agents, polysaccharides, ultraviolet absorbers, infrared absorbers, antioxidants, ion-exchange resins, and metal oxides such as titanium oxide, according to the purpose.

The optically anisotropic body of the present invention will be described below. The optically anisotropic body produced by polymerizing the polymerizable (liquid crystal) composition of the present invention can be used for various applications. For example, in the case where the polymerizable compound-containing liquid crystal composition of the present invention is polymerized while the molecules are not aligned, the resulting optically anisotropic body can be used as a light scattering plate, a depolarizing plate, or a moire fringe preventing plate. The optically anisotropic body produced by polymerizing the polymerizable compound-containing liquid crystal composition while the molecules are aligned has optical anisotropy as physical properties and is thus useful. The optically anisotropic body can be produced as follows: For example, the polymerizable compound-containing liquid crystal composition is provided on a surface of a substrate that has been subjected to a rubbing process with, for example, a fabric, on a surface of an organic thin film formed on a substrate, the organic thin film having been subjected to a rubbing process with, for example, a fabric, or on a substrate having a SiO₂ alignment layer formed by oblique deposition. Or alternately, the composition is provided between substrates. Then the liquid crystal of the present invention is polymerized.

Examples of a method for providing the polymerizable compound-containing liquid crystal composition on a substrate include spin coating, die coating, extrusion coating, roll coating, wire-bar coating, gravure coating, spray coating, dipping, and a printing method. In the case of coating, the polymerizable compound-containing liquid crystal composition may be used as it is. Alternatively, an organic solvent may be added thereto. Examples of the organic solvent include ethyl acetate, tetrahydrofuran, toluene, hexane, methanol, ethanol, dimethylformamide, dichloromethane, isopropanol, acetone, methyl ethyl ketone, acetonitrile, cellosolve, cyclohexanone, γ-butyrolactone, acetoxy-2-ethoxyethane, propylene glycol monomethyl acetate, and N-methylpyrrolidinone. These solvents may be used alone or in combination and may be appropriately selected in view of the vapor pressure and the solubility of the polymerizable compound-containing liquid crystal composition therein. The amount added is preferably 90% or less by weight. As a method for evaporating the organic solvent added, air drying, drying by heating, drying under reduced pressure, or drying by heating under reduced pressure may be used. To further improve the coating properties of the polymerizable liquid crystal material, it is effective in arranging an intermediate layer such as a polyimide thin film on a substrate and adding a levelling agent to the polymerizable liquid crystal material. The arrangement of the intermediate layer such as a polyimide thin film is also effective as a means for improving adhesion when the adhesion between a substrate and the optically anisotropic body produced by polymerizing the polymerizable liquid crystal material.

An example of a method for providing the polymerizable compound-containing liquid crystal composition between substrates is an injection method using a capillary phenomenon. A one drop fill (ODF) method and a means to reduce pressure in a space formed between substrates and then inject a liquid crystal material thereinto are effective.

Examples of an alignment process other than the rubbing process or the oblique deposition of SiO₂ include the use of flow alignment of a liquid crystal material, the use of an electric field, and the use of a magnetic field. These alignment means may be used alone or in combination. As an alignment process in place of rubbing, a photoalignment method may be used. In this method, for example, an organic thin film composed of, for example, poly(vinyl cinnamate) having a photodimerizable functional group in its molecule, an organic thin film having a photoisomerizable functional group, or an organic thin film composed of, for example, polyimide is irradiated with polarized light, preferably polarized ultraviolet light to form an alignment film. Alignment patterning can be easily performed by the photoalignment method with a photomask. Thus, molecule alignment in the optically anisotropic body can be precisely controlled.

The substrate may have a flat plate shape or a curved surface portion. The substrate may be composed of any material, regardless of an organic material or inorganic material. Examples of the organic material constituting the substrate include poly(ethylene terephthalate), polycarbonate, polyimide, polyamide, poly(methyl methacrylate), polystyrene, poly(vinyl chloride), polytetrafluoroethylene, polychlorotrifluoroethylene, polyarylate, polysulfone, cellulose triacetate, cellulose, and poly(ether ether ketone). Examples of the inorganic material include silicon, glass, and calcite.

In the case where appropriate alignment is not obtained by rubbing the substrate with, for example, a fabric, an organic thin film such as a polyimide thin film or a poly(vinyl alcohol) thin film may be formed on a surface of the substrate and then rubbed with, for example, a fabric according to a known method. The polyimide thin film, which is used for usual TN or STN liquid crystal devices and provides a pretilt angle, is particularly preferred because a molecular alignment structure in the optically anisotropic body can be more precisely controlled.

In the case of controlling an alignment state by an electric field, a substrate having an electrode layer is used. In this case, the organic thin film such as a polyimide thin film is preferably formed on the electrode.

As a method for polymerizing the liquid crystal composition of the present invention, a polymerization method by irradiation with an active energy ray such as ultraviolet light or an electronic beam is preferred because rapid polymerization is desirable. In the case of using ultraviolet light, a polarized light source may be used. Alternatively, a non-polarized light source may be used. In the case where the liquid crystal composition is polymerized while being held between two substrates, at least one substrate located on an irradiation side needs to be appropriately transparent to the active energy ray. The following means may be employed: Only a specific portion is polymerized by light irradiation using a mask. Then the alignment state of an unpolymerized portion is changed by changing conditions such as an electric field, a magnetic field, and temperature. Subsequently, the composition is polymerized by further irradiation with the active energy ray. The temperature during the irradiation is preferably within a temperature range in which the liquid crystal state of the liquid crystal composition of the present invention is maintained. In particular, in the case of where the optically anisotropic body is produced by photopolymerization, the liquid crystal composition is preferably polymerized at a temperature as close to room temperature as possible, that is, typically 25° C. in order to avoid inducing unintended thermal polymerization. The active energy ray preferably has an intensity of 0.1 mW/cm² to 2 W/cm². The use of an intensity of 0.1 mW/cm² or less requires plenty of time to complete the photopolymerization, thereby decreasing the productivity. The use of an intensity of 2 W/cm² or more may degrade the polymerizable liquid crystal compound or the polymerizable compound-containing liquid crystal composition.

The optically anisotropic body of the present invention produced by polymerization may be subjected to heat treatment in order to reduce changes in initial properties to achieve the development of stable properties. The heat-treatment temperature is preferably in the range of 50° C. to 250° C. The heat-treatment time is preferably in the range of 30 seconds to 12 hours.

The optically anisotropic body of the present invention produced by the method may be separated from the substrate and then used itself or may be used without being separated from the substrate. The resulting optically anisotropic body may be stacked or may be bonded to another substrate before use.

### EXAMPLES

### Example 1

Into a reaction vessel equipped with a stirrer, a condenser, and a thermometer, 35 g (155 mmol) of 4-(benzyloxy)phenylboronic acid, 30.5 g (150 mmol) of 4-bromo-2-methoxyphenol, 32 g (232 mmol) of potassium carbonate, 1.8 g of tetrakis(triphenylphosphine)palladium, 200 ml of tetrahydrofuran, and 100 ml of deionized water were charged. The mixture was reacted at 70° C. for 5 hours. After the reaction was completed, the mixture was cooled, and then 10% hydrochloric acid was added thereto. A target compound was extracted with ethyl acetate. The organic layer was washed with water and saturated saline, and the solvent was removed by evaporation. The mixture was dispersed and washed with toluene. The dispersion was subjected to purification on an alumina column to give 37 g of a compound represented by formula (1).

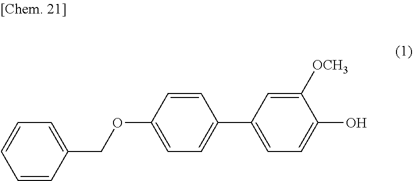 [SMILES: COc1cc(-c2ccc(OCc3ccccc3)cc2)ccc1O]

Into an autoclave equipped with a stirrer, 37 g of the compound represented by formula (1) and 250 ml of THF were charged. Then 25 ml of an ethanol solution and 1.8 g of 5% palladium on carbon (wetted with water) were added thereto. The mixture was subjected to catalytic hydrogen reduction with hydrogen gas. After the reaction was completed, the reaction mixture was filtered. Removal of the solvent by evaporation gave 25 g of a compound represented by formula (2).

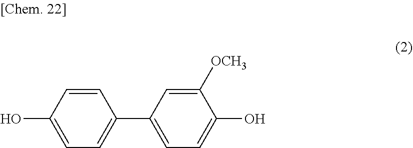 [SMILES: COc1cc(-c2ccc(O)cc2)ccc1O]

Into a reaction vessel equipped with a stirrer, a condenser, and a thermometer, 25 g (115 mmol) of the compound represented by formula (2), 23.9 g (277 mmol) of methacrylic acid, 1.7 g of dimethylaminopyridine, and 450 ml of dichloromethane were charged. The reaction vessel was maintained at 5° C. or lower in an ice bath, and 35 g (277 mmol) of diisopropylcarbodiimide was slowly added dropwise thereto in a nitrogen gas atmosphere. After the dropwise addition was completed, the reaction vessel was brought to room temperature, and the reaction was performed for 5 hours. After the reaction mixture was filtered, 150 ml of dichloromethane was added to the filtrate. The mixture was washed with 5% hydrochloric acid and then saturated saline. The organic layer was dried over anhydrous sodium sulfate. After the solvent was removed by evaporation, purification was performed by column chromatography with a double amount (ratio by weight) of silica gel to give 32 g of a target compound represented by formula (3).

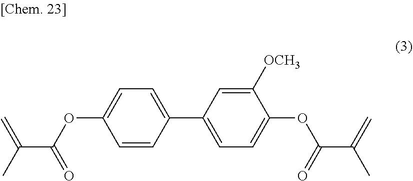 [SMILES: C=C(C)C(=O)Oc1ccc(-c2ccc(OC(=O)C(=C)C)c(OC)c2)cc1]

### (Physical Properties)

¹H-NMR (solvent: deuterated chloroform): δ: 2.12 (s, 6H), 3.85 (s, 3H), 5.77 (s, 2H), 6.38 (s, 2H), 7.11-7.25 (m, 5H), 7.54-7.58 (m, 2H)

¹³C-NMR (solvent: deuterated chloroform): δ: 17.9, 55.8, 113.2, 121.5, 122.3, 123.5, 128.1, 129.4, 137.2, 143.8, 150.3, 151.4, 166.4

Infrared absorption spectrum (IR) (KBr): 1760, 1652-1622, 809 cm⁻¹

Melting point: 101° C.

### Example 2

Into a reaction vessel equipped with a stirrer, a condenser, and a thermometer, 39 g (150 mmol) of 4-benzyloxy-3-methoxyphenylboronic acid, 28.5 g (140 mmol) of 4-bromo-2-methoxyphenol, 32 g of (232 mmol) of potassium carbonate, 1.6 g of tetrakis(triphenylphosphine)palladium, 200 ml of tetrahydrofuran, and 100 ml of deionized water were charged. The mixture was reacted at 70° C. for 5 hours. After the reaction was completed, the mixture was cooled, and then 10% hydrochloric acid was added thereto. A target compound was extracted with ethyl acetate. The organic layer was washed with water and saturated saline, and the solvent was removed by evaporation. The mixture was dispersed and washed with toluene. The dispersion was subjected to purification on an alumina column to give 40 g of a compound represented by formula (4).

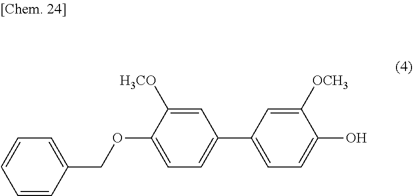 [SMILES: COc1cc(-c2ccc(OCc3ccccc3)c(OC)c2)ccc1O]

Into an autoclave equipped with a stirrer, 40 g of the compound represented by formula (4) and 250 ml of THF were charged. Then 25 ml of an ethanol solution and 1.8 g of 5% palladium on carbon (wetted with water) were added thereto. The mixture was subjected to catalytic hydrogen reduction with hydrogen gas. After the reaction was completed, the reaction mixture was filtered. Removal of the solvent by evaporation gave 28 g of a compound represented by formula (5).

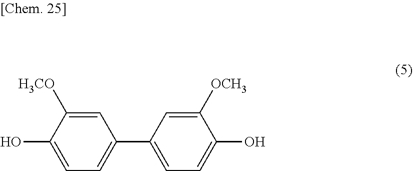 [SMILES: COc1cc(-c2ccc(O)c(OC)c2)ccc1O]

Into a reaction vessel equipped with a stirrer, a condenser, and a thermometer, 28 g (114 mmol) of the compound represented by formula (5), 23.9 g (277 mmol) of methacrylic acid, 1.7 g of dimethylaminopyridine, and 450 ml of dichloromethane were charged. The reaction vessel was maintained at 5° C. or lower in an ice bath, and 35 g (277 mmol) of diisopropylcarbodiimide was slowly added dropwise thereto in a nitrogen gas atmosphere. After the dropwise addition was completed, the reaction vessel was brought to room temperature, and the reaction was performed for 5 hours. After the reaction mixture was filtered, 150 ml of dichloromethane was added to the filtrate. The mixture was washed with 5% hydrochloric acid and then saturated saline. The organic layer was dried over anhydrous sodium sulfate. After the solvent was removed by evaporation, purification was performed by column chromatography with a double amount (ratio by weight) of silica gel to give 37 g of a target compound represented by formula (6).

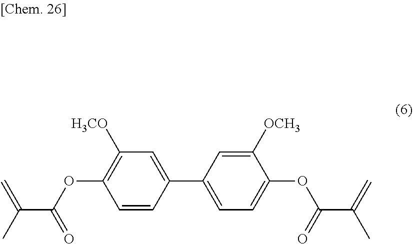 [SMILES: C=C(C)C(=O)Oc1ccc(-c2ccc(OC(=O)C(=C)C)c(OC)c2)cc1OC]

### (Physical Properties)

¹H-NMR (solvent: deuterated chloroform): δ: 2.12 (s, 6H), 3.87 (s, 6H), 5.77 (s, 2H), 6.39 (s, 2H), 7.11 (s, 6H)

¹³C-NMR (solvent: deuterated chloroform): δ: 17.9, 55.8, 113.1, 121.8, 123.5, 128.1, 137.2, 143.8, 150.3, 151.4, 166.4

Infrared absorption spectrum (IR) (KBr): 1760, 1652-1622, 809 cm⁻¹

Melting point: 125° C.

### Example 3

Into a reaction vessel equipped with a stirrer, a condenser, and a thermometer, 27.5 g (90 mmol) of the compound represented by formula (1), which was synthesized in Example (1), 12 g of (107 mmol) of ethylene glycol mono-tert-butyl ether, 35 g (134 mmol) of triphenylphosphine, and 300 ml of dichloromethane were charged. The reaction vessel was cooled to 5° C. Then 22 g (107 mmol) of diisopropyl azodicarboxylate (DIAD) was added dropwise thereto. After the dropwise addition was completed, the mixture was stirred at room temperature for 5 hours to complete the reaction. After the reaction was completed, 200 ml of dichloromethane was added thereto. The organic layer was washed with deionized water and saturated saline. After the solvent was removed by evaporation, purification was performed on a silica-gel column to give 32 g of a compound represented by formula (7).

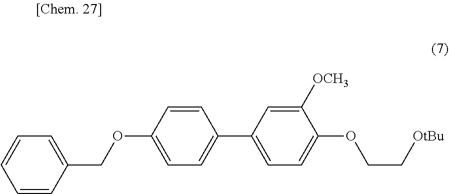 [SMILES: COc1cc(-c2ccc(OCc3ccccc3)cc2)ccc1OCCOC(C)(C)C]

Into an autoclave equipped with a stirrer, 32 g of the compound represented by formula (7) and 220 ml of THF were charged. Then 22 ml of an ethanol solution and 1.6 g of 5% palladium on carbon (wetted with water) were added thereto. The mixture was subjected to catalytic hydrogen reduction with hydrogen gas. After the reaction was completed, the reaction mixture was filtered. Removal of the solvent by evaporation gave 23 g of a compound represented by formula (8).

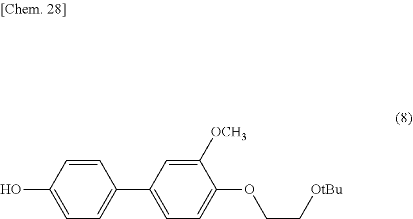 [SMILES: COc1cc(-c2ccc(O)cc2)ccc1OCCOC(C)(C)C]

Into a reaction vessel equipped with a stirrer, a condenser, and a thermometer, 23 g (72 mmol) of the compound represented by formula (8), 7.5 g (87 mmol) of methacrylic acid, 530 mg of dimethylaminopyridine, and 100 ml of dichloromethane were charged. The reaction vessel was maintained at 5° C. or lower in an ice bath, 11 g (87 mmol) of diisopropylcarbodiimide was slowly added dropwise thereto in a nitrogen gas atmosphere. After the dropwise addition was completed, the reaction vessel was brought to room temperature, and the reaction was performed for 5 hours. After the reaction mixture was filtered, 150 ml of dichloromethane was added to the filtrate. The mixture was washed with 5% hydrochloric acid and then saturated saline. The organic layer was dried over anhydrous sodium sulfate. After the solvent was removed by evaporation, purification was performed on a column with a double amount (ratio by weight) of alumina. Recrystallization from a mixture of dichloromethane and hexane gave 23 g of a compound represented by formula (9).

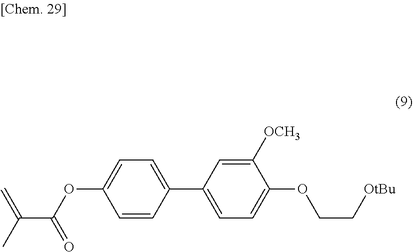 [SMILES: C=C(C)C(=O)Oc1ccc(-c2ccc(OCCOC(C)(C)C)c(OC)c2)cc1]

Into a reaction vessel equipped with a stirrer, a condenser, and a thermometer, 23 g of the compound represented by formula (9) and 20 ml of dichloromethane were charged. The reaction vessel was maintained at 5° C. or lower in an ice bath, and 70 ml of trifluoroacetic acid was slowly added dropwise thereto. After the dropwise addition was completed, the reaction vessel was brought to room temperature, and the reaction was performed for 1 hour. After the reaction was completed, the reaction mixture was cooled to 10° C. or lower, and 50 ml of deionized water was slowly added thereto. Then 150 ml of dichloromethane was added thereto. The organic layer was washed with deionized water, a saturated sodium bicarbonate solution, 5% hydrochloric acid, and saturated saline. The organic layer was dried over anhydrous sodium sulfate. Removal of the solvent by evaporation gave 18 g of a target compound represented by formula (10).

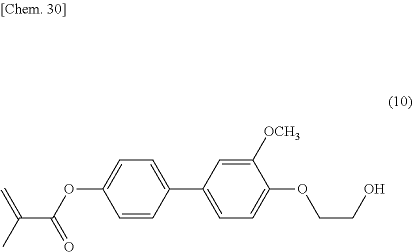 [SMILES: C=C(C)C(=O)Oc1ccc(-c2ccc(OCCO)c(OC)c2)cc1]

Into a reaction vessel equipped with a stirrer, a condenser, and a thermometer, 18 g (55 mmol) of the compound represented by formula (10), 9.8 g (55 mmol) of 4-methacryloyloxyphenol, 17.3 g (66 mmol) of triphenylphosphine, and 150 ml of dichloromethane were charged. The reaction vessel was cooled to 5° C., and then 13.4 g (66 mmol) of DIAD was added dropwise. After the dropwise addition was completed, the mixture was stirred at room temperature for 5 hours to complete the reaction. After the reaction was completed, 200 ml of dichloromethane was added thereto. The organic layer was washed with deionized water and saturated saline. After the solvent was removed by evaporation, purification was performed by silica-gel column chromatography to give 18.8 g of a compound represented by formula (11).

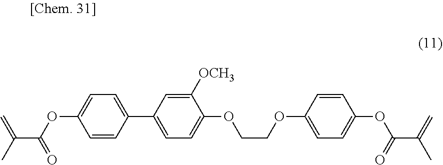 [SMILES: C=C(C)C(=O)Oc1ccc(OCCOc2ccc(-c3ccc(OC(=O)C(=C)C)cc3)cc2OC)cc1]

### (Physical Properties)

¹H-NMR (solvent: deuterated chloroform): δ: 2.06 (d, 6H), 3.96 (s, 3H), 4.39 (dd, 4H), 5.74 (dd, 2H), 6.33 (dd, 2H), 6.38-6.94 (m, 2H), 7.03-7.05 (m, 3H), 7.09-7.11 (m, 2H), 7.12-7.19 (m, 2H), 7.52-7.53 (m, 2H)

¹³C-NMR (solvent: deuterated chloroform): δ: 17.8, 56.1, 68.9, 69.2, 111.2, 113.6, 114.8, 118.0, 122.1, 128.2, 129.5, 135.3, 136.2, 137.6, 138.3, 142.9, 149.5, 150.4, 166.0

Infrared absorption spectrum (IR) (KBr): 1760, 1652-1622, 809 cm⁻¹

Melting point: 141° C.

### Example 4

Into a reaction vessel equipped with a stirrer, a condenser, and a thermometer, 40 g (155 mmol) of 2-(4-bromophenoxy)tetrahydropyran, 21 g (155 mmol) of 4-hydroxyphenylboronic acid, 32 g of (232 mmol) of potassium carbonate, 1.8 g of tetrakis(triphenylphosphine)palladium, 200 ml of tetrahydrofuran, and 100 ml of deionized water were charged. The mixture was reacted at 70° C. for 5 hours. After the reaction was completed, the mixture was cooled, and then 10% hydrochloric acid was added thereto. A target compound was extracted with ethyl acetate. The organic layer was washed with water and saturated saline, and the solvent was removed by evaporation. The mixture was dispersed and washed with toluene. The dispersion was subjected to purification on an alumina column to give 27 g of a compound represented by formula (12)1.

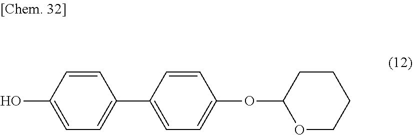 [SMILES: Oc1ccc(-c2ccc(OC3CCCCO3)cc2)cc1]

Into a reaction vessel equipped with a stirrer, a condenser, and a thermometer, 15 g (55 mmol) of the compound represented by formula (12), 7 g of triethylamine, and 100 ml of tetrahydrofuran were charged. The reaction vessel was maintained at 5° C. or lower in an ice bath, 6 g (66 mmol) of acryloyl chloride was slowly added dropwise thereto in a nitrogen gas atmosphere. After the dropwise addition was completed, the reaction vessel was brought to room temperature, and the reaction was performed for 5 hours. After the reaction mixture was filtered, ethyl acetate was added to the filtrate. The mixture was washed with 5% hydrochloric acid and then saturated saline. The organic layer was dried over anhydrous sodium sulfate. After the solvent was removed by evaporation, purification was performed on a column with a double amount (ratio by weight) of alumina to give 15 g of a compound represented by formula (13).

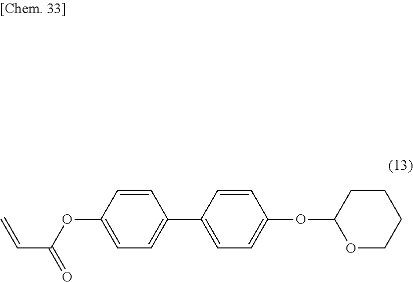 [SMILES: C=CC(=O)Oc1ccc(-c2ccc(OC3CCCCO3)cc2)cc1]

Into a reaction vessel equipped with a stirrer and a thermometer, 15 g of the compound represented by formula (13) and 100 ml of THF were charged. A mixture of 10 ml of a methanol solution and 1 ml of hydrochloric acid were slowly added dropwise. After the dropwise addition was completed, the reaction was performed for another 2 hours. After the reaction was completed, 200 ml of ethyl acetate was added to the reaction mixture. The organic layer was washed with deionized water, a saturated sodium bicarbonate solution, 5% hydrochloric acid, and saturated saline. The organic layer was dried over anhydrous sodium sulfate. Removal of the solvent by evaporation gave 11 g of a compound represented by formula (14).

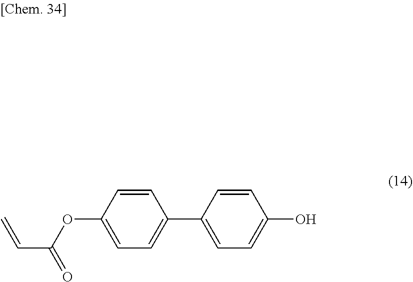 [SMILES: C=CC(=O)Oc1ccc(-c2ccc(O)cc2)cc1]

Into a reaction vessel equipped with a stirrer, a condenser, and a thermometer, 11 g represented by formula (14), 13.3 g (45.7 mmol) of 3-(3,4-acryloyloxy)phenyl)propionic acid, 270 mg of dimethylaminopyridine, and 150 ml of dichloromethane were charged. The reaction vessel was maintained at 5° C. or lower in an ice bath, 6.8 g (54 mmol) of diisopropylcarbodiimide was slowly added dropwise thereto in a nitrogen gas atmosphere. After the dropwise addition was completed, the reaction vessel was brought to room temperature, and the reaction was performed for 5 hours. After the reaction mixture was filtered, 150 ml of dichloromethane was added to the filtrate. The mixture was washed with 5% hydrochloric acid and saturated saline. The organic layer was dried over anhydrous sodium sulfate. After the solvent was removed by evaporation, purification was performed by column chromatography with a double amount (ratio by weight) of silica gel to give 20 g of a compound represented by formula (15).

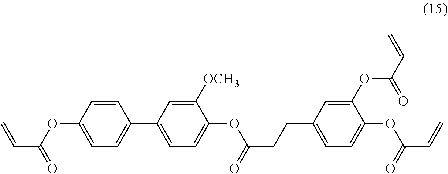 [SMILES: C=CC(=O)Oc1ccc(-c2ccc(OC(=O)CCc3ccc(OC(=O)C=C)c(OC(=O)C=C)c3)c(OC)c2)cc1]

### (Physical Properties)

¹H-NMR (solvent: deuterated chloroform): δ: 2.73 (t, 3H), 2.85 (t, 3H), 3.93 (s, 3H), 5.74-5.78 (m, 2H), 6.10-6.13 (m, 2H), 6.24-6.31 (m, 2H), 6.91-7.05 (m, 3H), 7.12-7.15 (m, 3H), 7.34-7.39 (m, 2H), 7.71 (d, 2H),

¹³C-NMR (solvent: deuterated chloroform): δ: 30.5, 33.7, 55.8, 113.4, 121.8, 122.0, 123.0, 123.3, 123.4, 123.9, 126.6, 127.1, 127.4, 128.0, 133.1, 135.7, 138.8, 140.5, 141.9, 145.6, 150.2, 150.7, 163.3, 165.7, 170.1, 172.3

Infrared absorption spectrum (IR) (KBr): 1760, 1652-1622, 809 cm⁻¹

### Example 5

Into a reaction vessel equipped with a stirrer, a condenser, and a thermometer, 31 g (155 mmol) of 4-bromo-2-methoxyphenol, 38 g (155 mmol) of 4-benzyloxy-2-fluorophenylboronic acid, 32 g (232 mmol) of potassium carbonate, 1.8 g of tetrakis(triphenylphosphine)palladium, 300 ml of tetrahydrofuran, and 100 ml of deionized water were charged. The mixture was reacted at 70° C. for 5 hours. After the reaction was completed, the mixture was cooled, and then 10% hydrochloric acid was added thereto. A target compound was extracted with ethyl acetate. The organic layer was washed with water and saturated saline, and the solvent was removed by evaporation. The mixture was dispersed and washed with toluene. The dispersion was subjected to purification on an alumina column to give 39 g of a compound represented by formula (16)1.

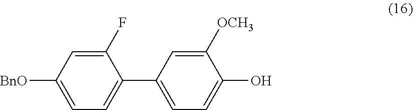 [SMILES: COc1cc(-c2ccc(OCc3ccccc3)cc2F)ccc1O]

Into an autoclave equipped with a stirrer, 39 g of the compound represented by formula (16) and 250 ml of THF were charged. Then 25 ml of an ethanol solution and 1.8 g of 5% palladium on carbon (wetted with water) were added thereto. The mixture was subjected to catalytic hydrogen reduction with hydrogen gas. After the reaction was completed, the reaction mixture was filtered. Removal of the solvent by evaporation gave 29 g of a compound represented by formula (17).

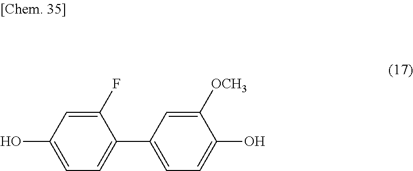 [SMILES: COc1cc(-c2ccc(O)cc2F)ccc1O]

Into a reaction vessel equipped with a stirrer, a condenser, and a thermometer, 29 g (123 mmol) of the compound represented by formula (17), 25.4 g (295 mmol) of methacrylic acid, 1.7 g of dimethylaminopyridine, and 450 ml of dichloromethane were charged. The reaction vessel was maintained at 5° C. or lower in an ice bath, and 37 g (295 mmol) of diisopropylcarbodiimide was slowly added dropwise thereto in a nitrogen gas atmosphere. After the dropwise addition was completed, the reaction vessel was brought to room temperature, and the reaction was performed for 5 hours. After the reaction mixture was filtered, 150 ml of dichloromethane was added to the filtrate. The mixture was washed with 5% hydrochloric acid and then saturated saline. The organic layer was dried over anhydrous sodium sulfate. After the solvent was removed by evaporation, purification was performed by column chromatography with a double amount (ratio by weight) of silica gel to give 35 g of a target compound represented by formula (18).

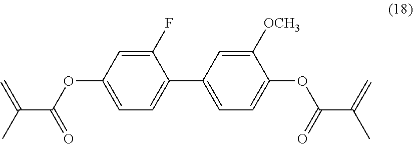 [SMILES: C=C(C)C(=O)Oc1ccc(-c2ccc(OC(=O)C(=C)C)c(OC)c2)c(F)c1]

### (Physical Properties)

¹H-NMR (solvent: deuterated chloroform): δ: 2.08 (s, 6H), 3.86 (s, 3H), 5.77 (s, 2H), 6.38 (s, 2H), 6.99-7.02 (m, 2H), 7.09-7.15 (m, 3H), 7.41 (m, 1H)

¹³C-NMR (solvent: deuterated chloroform): δ: 17.9, 55.8, 110.2, 113.4, 117.7, 121.8, 123.5, 125.8, 128.1, 134.3, 135.3, 137.3, 151.1, 159.1, 166.0,

Infrared absorption spectrum (IR) (KBr): 1760, 1652-1622, 809 cm⁻¹

Melting point: 81° C.

### Example 6

Into a reaction vessel equipped with a stirrer, a condenser, and a thermometer, 30.8 g (90 mmol) of 4′-benzoyloxy-3,5-difluoro-3′-methoxy(1,1′-biphenyl)-4-ol, 12 g (107 mmol) of ethylene glycol mono-tert-butyl ether, 35 g (134 mmol) of triphenylphosphine, and 300 ml of dichloromethane were charged. The reaction vessel was cooled to 5° C. Then 22 g (107 mmol) of diisopropyl azodicarboxylate (DIAD) was added dropwise thereto. After the dropwise addition was completed, the mixture was stirred at room temperature for 5 hours to complete the reaction. After the reaction was completed, 200 ml of dichloromethane was added thereto. The organic layer was washed with deionized water and saturated saline. After the solvent was removed by evaporation, purification was performed on a silica-gel column to give 33 g of a compound represented by formula (19).

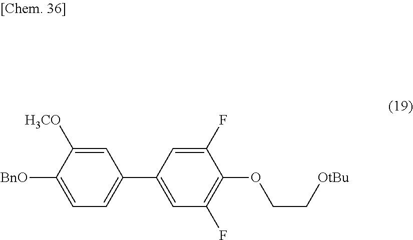 [SMILES: COc1cc(-c2cc(F)c(OCCOC(C)(C)C)c(F)c2)ccc1OCc1ccccc1]

Into an autoclave equipped with a stirrer, 33 g of the compound represented by formula (19) and 220 ml of THF were charged. Then 22 ml of an ethanol solution and 1.6 g of 5% palladium on carbon (wetted with water) were added thereto. The mixture was subjected to catalytic hydrogen reduction with hydrogen gas. After the reaction was completed, the reaction mixture was filtered. Removal of the solvent by evaporation gave 25 g of a compound represented by formula (20).

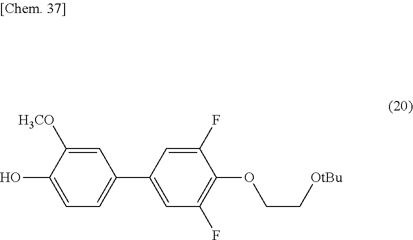 [SMILES: COc1cc(-c2cc(F)c(OCCOC(C)(C)C)c(F)c2)ccc1O]

Into a reaction vessel equipped with a stirrer, a condenser, and a thermometer, 25 g (71 mmol) of the compound represented by formula (20), 7.5 g (87 mmol) of methacrylic acid, 530 mg of dimethylaminopyridine, and 100 ml of dichloromethane were charged. The reaction vessel was maintained at 5° C. or lower in an ice bath, 11 g (87 mmol) of diisopropylcarbodiimide was slowly added dropwise thereto in a nitrogen gas atmosphere. After the dropwise addition was completed, the reaction vessel was brought to room temperature, and the reaction was performed for 5 hours. After the reaction mixture was filtered, 150 ml of dichloromethane was added to the filtrate. The mixture was washed with 5% hydrochloric acid and then saturated saline. The organic layer was dried over anhydrous sodium sulfate. After the solvent was removed by evaporation, purification was performed on a column with a double amount (ratio by weight) of alumina. Recrystallization from a mixture of dichloromethane and hexane gave 22 g of a compound represented by formula (21).

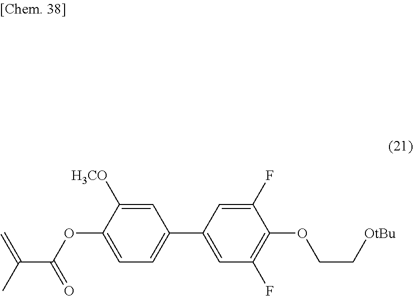 [SMILES: C=C(C)C(=O)Oc1ccc(-c2cc(F)c(OCCOC(C)(C)C)c(F)c2)cc1OC]

Into a reaction vessel equipped with a stirrer, a condenser, and a thermometer, 22 g of the compound represented by formula (21) and 20 ml of dichloromethane were charged. The reaction vessel was maintained at 5° C. or lower in an ice bath, and 70 ml of trifluoroacetic acid was slowly added dropwise thereto. After the dropwise addition was completed, the reaction vessel was brought to room temperature, and the reaction was performed for 1 hour. After the reaction was completed, the reaction mixture was cooled to 10° C. or lower, and 50 ml of deionized water was slowly added thereto. Then 150 ml of dichloromethane was added thereto. The organic layer was washed with deionized water, a saturated sodium bicarbonate solution, 5% hydrochloric acid, and saturated saline. The organic layer was dried over anhydrous sodium sulfate. Removal of the solvent by evaporation gave 17 g of a target compound represented by formula (12).

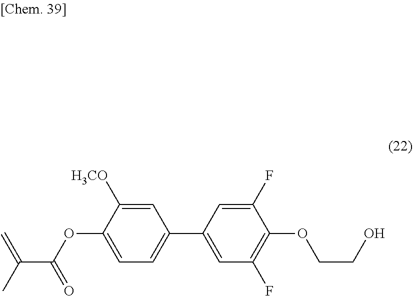 [SMILES: C=C(C)C(=O)Oc1ccc(-c2cc(F)c(OCCO)c(F)c2)cc1OC]

Into a reaction vessel equipped with a stirrer, a condenser, and a thermometer, 17 g (60 mmol) of the compound represented by formula (22), 12 g (60 mmol) of 2-fluoro-4-methacryloyloxyphenol, 17.3 g (66 mmol) of triphenylphosphine, and 150 ml of dichloromethane were charged. The reaction vessel was cooled to 5° C., and then 13.4 g (66 mmol) of DIAD was added dropwise. After the dropwise addition was completed, the mixture was stirred at room temperature for 5 hours to complete the reaction. After the reaction was completed, 200 ml of dichloromethane was added thereto. The organic layer was washed with deionized water and saturated saline. After the solvent was removed by evaporation, purification was performed by silica-gel column chromatography to give 17 g of a compound represented by formula (23).

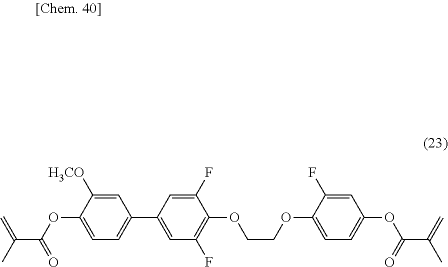 [SMILES: C=C(C)C(=O)Oc1ccc(OCCOc2c(F)cc(-c3ccc(OC(=O)C(=C)C)c(OC)c3)cc2F)c(F)c1]

### (Physical Properties)

¹H-NMR (solvent: deuterated chloroform): δ: 2.05 (s, 3H), 2.08 (s, 3H), 3.94 (s, 3H), 4.28-4.29 (m, 2H), 4.50-4.52 (m, 2H), 5.77 (d, 2H), 6.38 (d, 2H), 6, 91-6.94 (m, 2H), 7.03-7.13 (m, 6H)

¹³C-NMR (solvent: deuterated chloroform): δ: 17.9, 55.8, 68.9, 113.4, 116.8, 117.8, 121.8, 123.1, 128.6, 131.5, 137.3, 144.5, 144.6, 152.6, 153.8, 154.3, 166.3

Infrared absorption spectrum (IR) (KBr): 1760, 1652-1622, 809 cm⁻¹

Melting point: 81° C.

### Example 7

A polymerizable liquid crystal composition (composition 1) having a composition described below was prepared.

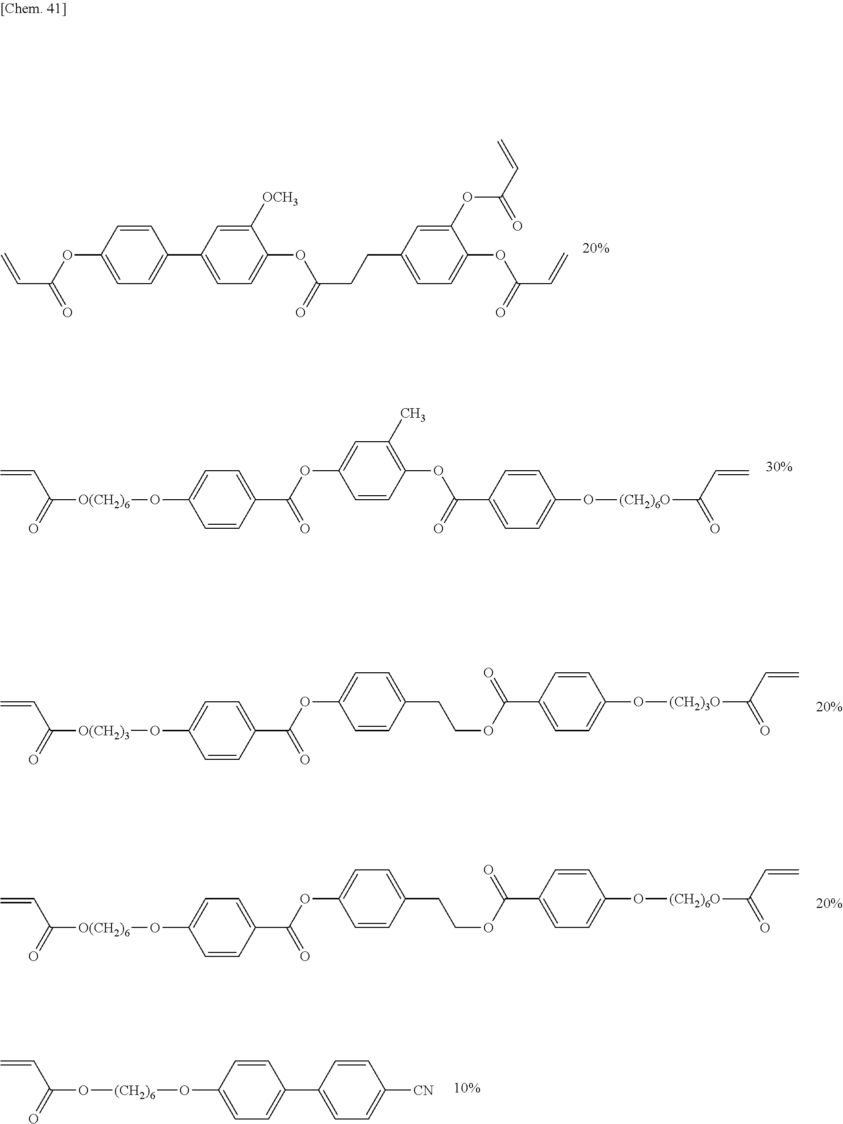

The polymerizable liquid crystal composition had good storage stability and exhibited a nematic liquid crystal phase in a wide temperature range. A photopolymerization initiator Irgacure 907 (available from Ciba Specialty Chemicals) was added to the polymerizable liquid crystal composition in an amount of 3% to prepare a polymerizable liquid crystal composition (composition 2). A solution of composition 2 in cyclohexanone was applied by spin coating to a glass substrate having a polyimide film subjected to a rubbing process, dried at 100° C. for 5 minutes, allowed to cool to room temperature, and irradiated with ultraviolet light using a high-pressure mercury-vapor lamp at an intensity of 4 mW/cm² for 120 seconds. Thereby, composition 2 was polymerized while maintaining a uniform alignment state, forming an optically anisotropic body. The optically anisotropic body had a surface hardness (according to JIS-S-K-5400) of H. The optically anisotropic body heated at 240° C. for 1 hour had a phase difference of 94% with respect to 100% of the phase difference of the optically anisotropic body before heating. A decrease in phase difference was 6%.

### Comparative Example 1

A polymerizable liquid crystal composition (composition 3) having a composition described below was prepared.

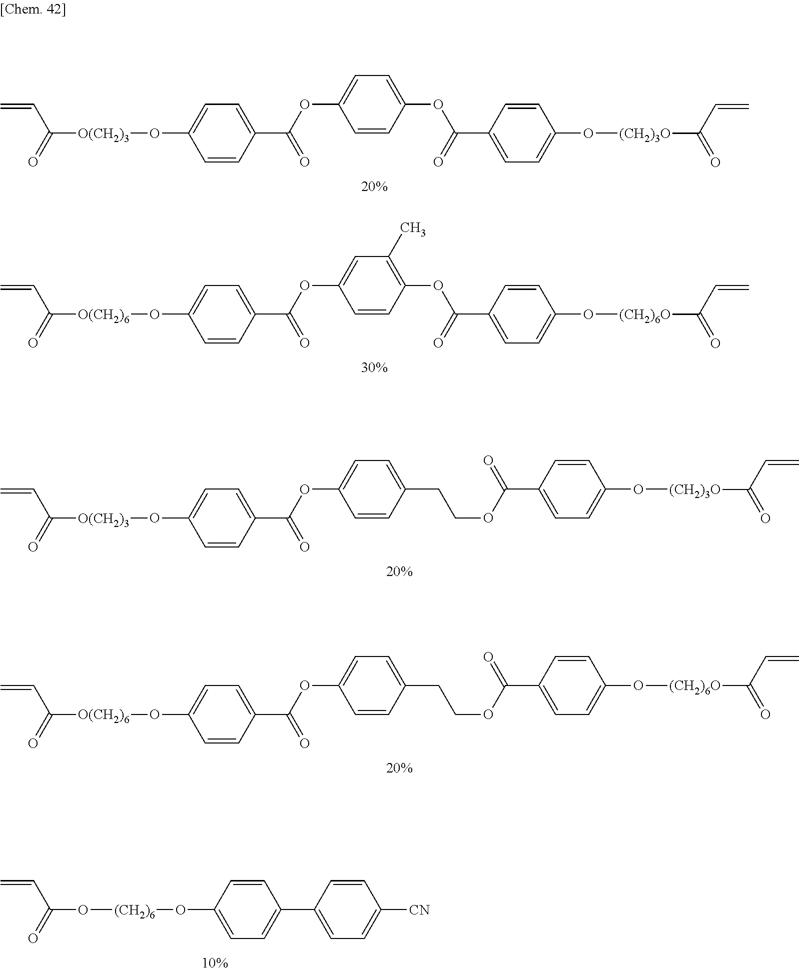

The polymerizable liquid crystal composition exhibited a nematic liquid crystal and had poor storage stability. The crystals precipitated at room temperature in eight hours.

### Comparative Example 2

A polymerizable liquid crystal composition (composition 4) having a composition described below was prepared.

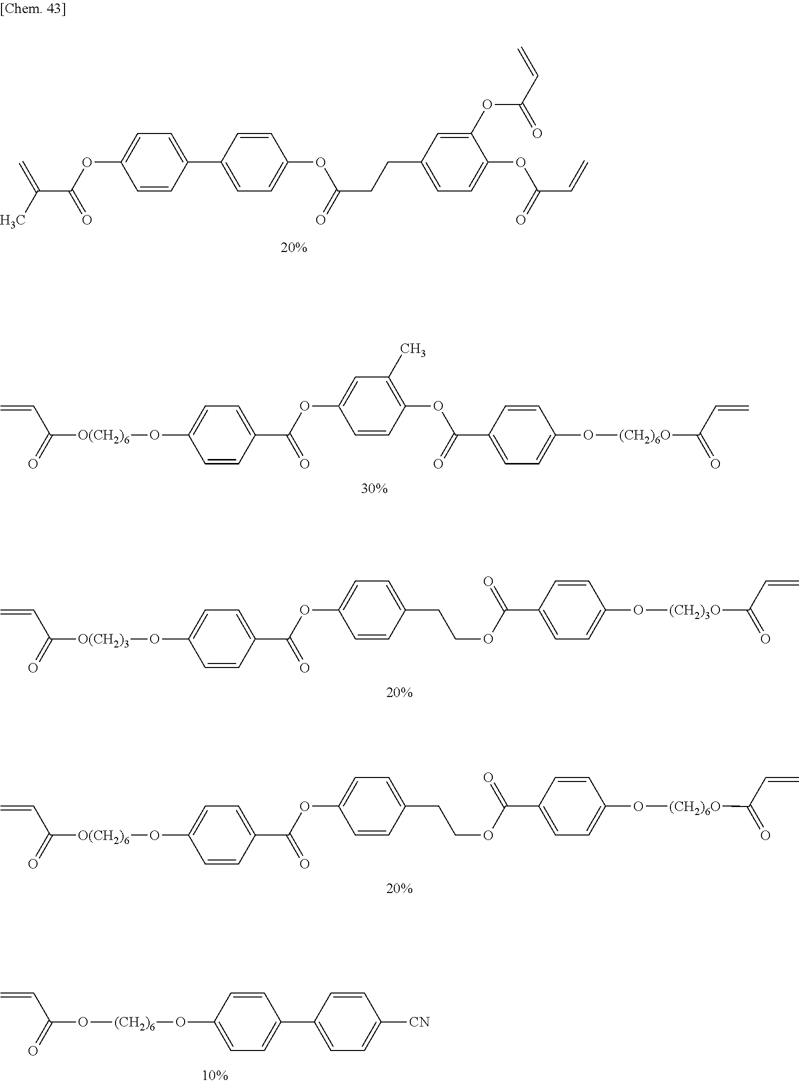

The polymerizable liquid crystal composition exhibited a nematic liquid crystal phase. Precipitates were observed one day later at room temperature, which indicated poor solubility.

### Example 8

Liquid crystal composition LC-1 containing the following compounds was prepared. The constituent compounds and the contents were described below.

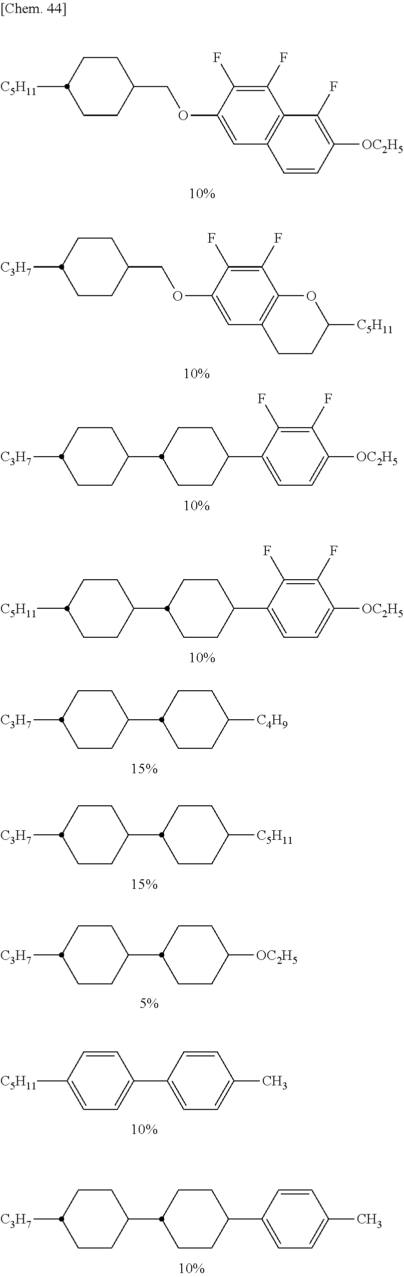

The compound represented by formula (3), which was synthesized in Example 1, was added to the liquid crystal composition LC-1 in an amount of 0.3%. The polymerizable liquid crystal composition had good storage stability because no precipitate was formed even when the polymerizable liquid crystal composition was stored at −10° C. for 1 week. The composition was injected into a VA glass cell provided with a 3.5-μm-thick polyimide film subjected to an alignment process, and irradiated with ultraviolet light at a dose of 5 J. The liquid crystal composition was extracted from the VA glass cell. Analysis of the liquid crystal composition for a residual monomer by high-performance liquid chromatography revealed that the residual monomer content was below the detection limit.

### Comparative Example 3

Liquid crystal composition LC-1 containing the following compounds was prepared. The constituent compounds and the contents were described below.

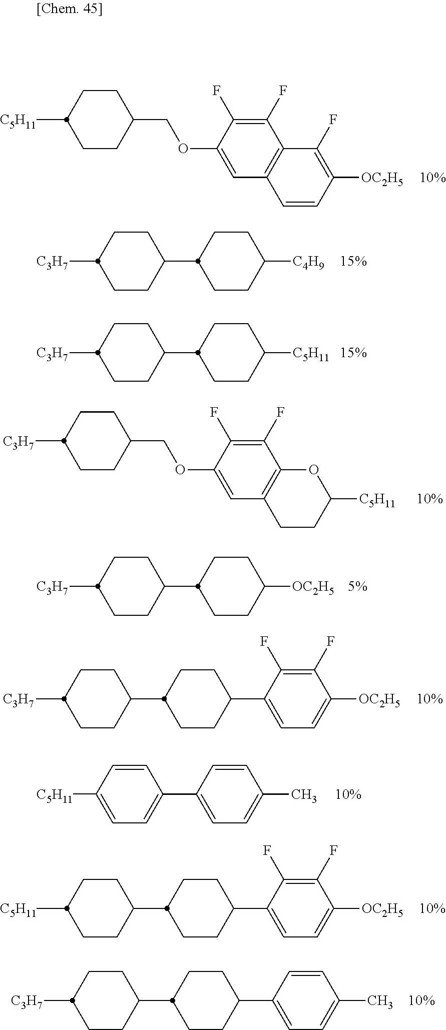

A compound represented by formula (16) illustrated below was added to liquid crystal composition LC-1 in an amount of 0.3%. The polymerizable liquid crystal composition had good storage stability because no precipitate was formed even when the polymerizable liquid crystal composition was stored at −10° C. for 1 week. The composition was injected into a VA glass cell provided with a 3.5-μm-thick polyimide film subjected to an alignment process, and irradiated with ultraviolet light at a dose of 5 J. The liquid crystal composition was extracted from the VA glass cell. Analysis of the liquid crystal composition for a residual monomer by high-performance liquid chromatography revealed that the monomer was detected in a concentration of 0.1%.

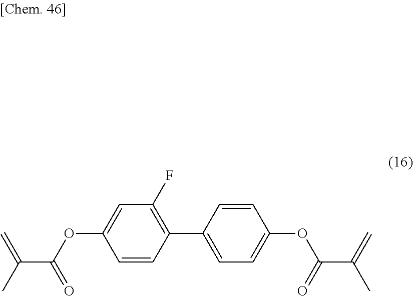 [SMILES: C=C(C)C(=O)Oc1ccc(-c2ccc(OC(=O)C(=C)C)cc2F)cc1]

### Example 9

Liquid crystal composition LC-2 containing the following compounds was prepared. The constituent compounds and the contents were described below.

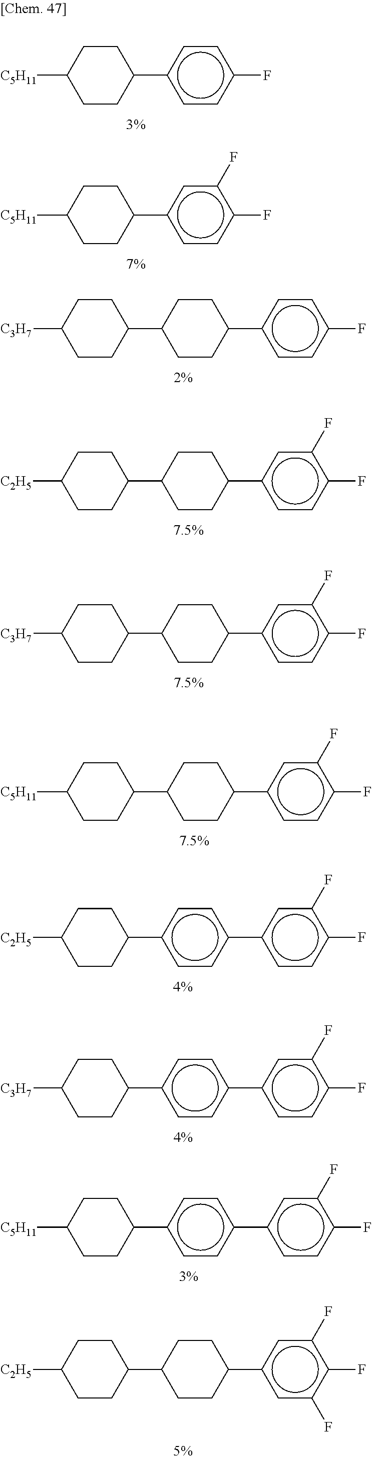

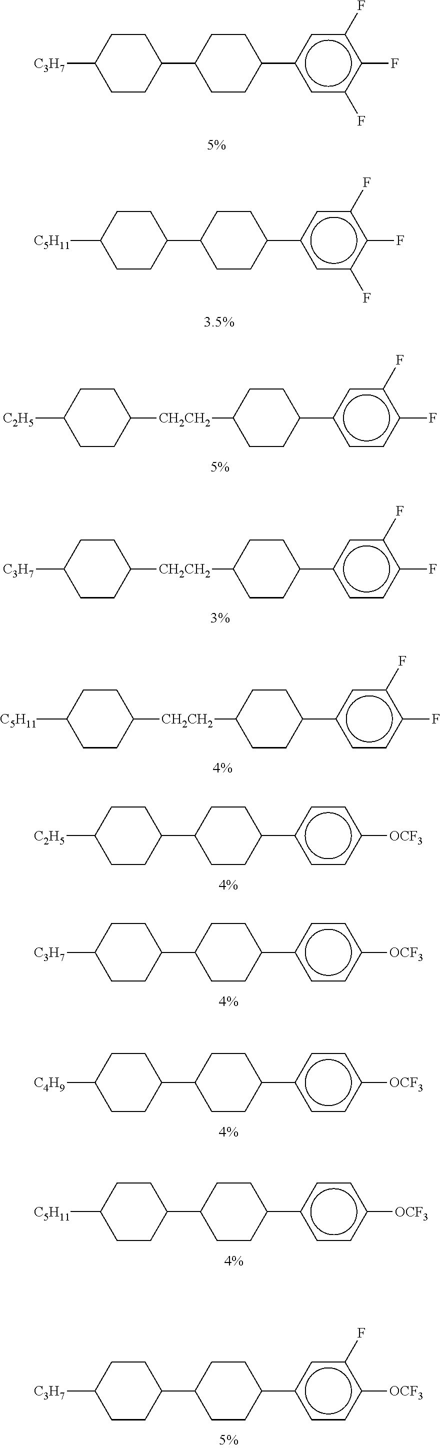

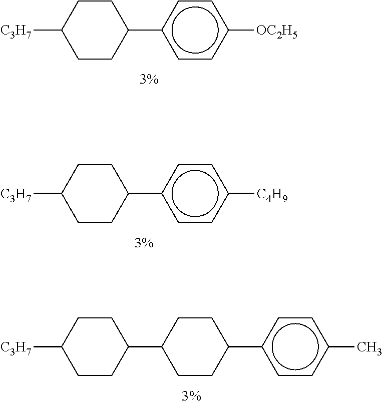

The physical properties of liquid crystal composition LC-2 were as follows: Tni=85° C., Δε=5.5, and Δn=0.090.

The compound represented by formula (3), which was synthesized in Example 1, was added to liquid crystal composition LC-1 in an amount of 0.3%. The polymerizable liquid crystal composition had good storage stability because no precipitate was formed even when the polymerizable liquid crystal composition was stored at −10° C. for 1 week. The composition was injected into an FFS glass cell provided with a 3.5-μm-thick polyimide film subjected to an alignment process, and irradiated with ultraviolet light at a dose of 5 J. The liquid crystal composition was extracted from the FFS glass cell. Analysis of the liquid crystal composition for a residual monomer by high-performance liquid chromatography revealed that the residual monomer content was below the detection limit.

### Comparative Example 4

The compound represented by formula (16) was added to liquid crystal composition LC-1 in an amount of 0.3%. The polymerizable liquid crystal composition had good storage stability because no precipitate was formed even when the polymerizable liquid crystal composition was stored at −10° C. for 1 week. The composition was injected into an FFS glass cell provided with a 3.5-μm-thick polyimide film subjected to an alignment process, and irradiated with ultraviolet light at a dose of 5 J. The liquid crystal composition was extracted from the FFS glass cell. Analysis of the liquid crystal composition for a residual monomer by high-performance liquid chromatography revealed that the monomer was detected in a concentration of 0.1%.

1-9. (canceled)

10. A polymerizable compound represented by general formula (I): 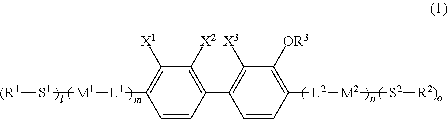
where in general formula (I), S¹ is at least one linking group selected from the group consisting of an alkylene group having 1 to 12 carbon atoms and a single bond, one —CH₂— group or two or more non-adjacent —CH₂— groups in the alkylene group are each optionally replaced with —O—, —COO—, —OCO—, or —OCOO—,
S² is at least one linking group selected from the group consisting of an alkylene group having 1 to 12 carbon atoms and a single bond, one —CH₂— group or two or more non-adjacent —CH₂— groups in the alkylene group are each optionally replaced with —O—, —COO—, or —OCOO—,
R¹ and R² are each independently a hydrogen atom or a group represented by any of formulae (R-1) to (R-15): 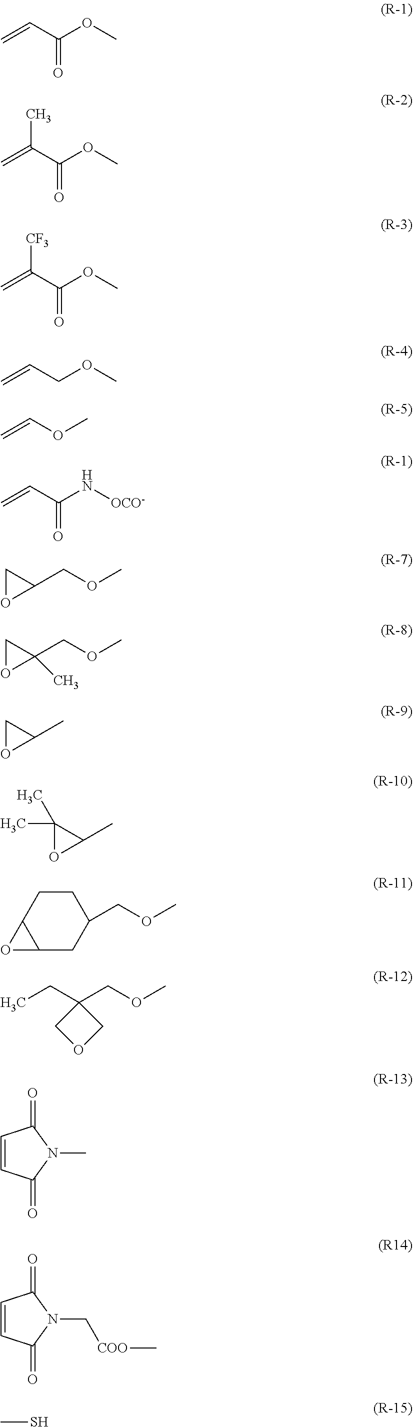
where R³ is an alkyl group having 1 to 4 carbon atoms,
L¹ is a single bond, —OCH₂—, —CH₂O—, —CO—, —C₂H₄—, —COO—, —OCO—, —OCOOCH₂—, —CH₂OCOO—, —OCH₂CH₂O—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —COOC₂H₄—, —OCOC₂H₄—, —C₂H₄OCO—, —CH₂OCO—, —COOCH₂—, —OCOCH₂—, —CH═CH—, —CF═CF—, —CF═CH—, —CH═CF—, —CF₂O—, —OCF₂—, —CF₂CH₂—, —CH₂CF₂—, —CF₂CF₂—, or —C≡C— (where in the formulae, each R^{a} is independently a hydrogen atom or an alkyl group having 1 to 4 carbon atoms), L² is —C₄H₈—, —OCH₂CH₂O—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —COOC₂H₄—, —OCOC₂H₄—, or —C₂H₄OCO— (where in the formulae, each R^{a} is independently a hydrogen atom or an alkyl group having 1 to 4 carbon atoms),
M¹ and M² are each independently
a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a 1,3-dioxane-2,5-diyl group, a 1,3,5-benzenetriyl group, a 1,3,4-benzenetriyl group, or a 1,3,4,5-benzenetetrayl group, M¹ and M² are each independently optionally replaced with an alkyl group, a halogenated alkyl group, an alkoxy group, a halogenated alkoxy group, a halogen, a cyano group, or a nitro group,
X¹ is a hydrogen atom, an alkyl group having 1 to 5 carbon atoms, a halogenated alkyl group having 1 to 5 carbon atoms, an alkoxy group having 1 to 5 carbon atoms, a halogenated alkoxy group having 1 to 5 carbon atoms, a cyano group, or a nitro group,
X², and X³ are each independently a hydrogen atom, an alkyl group having 1 to 5 carbon atoms, a halogenated alkyl group having 1 to 5 carbon atoms, an alkoxy group having 1 to 5 carbon atoms, a halogenated alkoxy group having 1 to 5 carbon atoms, a halogen atom, a cyano group, or a nitro group,
m and n are each independently an integer of 0 or 1, and l and o are each independently an integer of 1 or 2).

11. The polymerizable compound according to claim 10, wherein in general formula (I), L¹ is —OCH₂—, —CH₂O—, —COO—, —OCO—, —C₂H₄—, —C≡C—, —OCF₂—, —CF₂O—, or a single bond,
M¹ and M² are each independently a 1,4-cyclohexylene group, a 1,4-phenylene group, a naphthalene-2,6-diyl group, a 1,3,5-benzenetriyl group, a 1,3,4-benzenetriyl group, or a 1,3,4,5-benzenetetrayl group, M¹ and M² are each independently optionally replaced with an alkyl group, a halogenated alkyl group, an alkoxy group, a halogenated alkoxy group, a halogen, a cyano group, or a nitro group, and m is 1.

12. The polymerizable compound according to claim 10, wherein in general formula (I), m is 0.

13. The polymerizable compound according to claim 10, wherein in general formula (I), M² is a 1,3,5-benzenetriyl group, a 1,3,4-benzenetriyl group, or a 1,3,4,5-benzenetetrayl group, and n is 1.

14. A polymerizable composition comprising the polymerizable compound according to claim 10.

15. The polymerizable composition according to claim 14, wherein the polymerizable composition exhibits a liquid crystal phase.

16. A polymerizable compound-containing liquid crystal composition according to claim 10, the polymerizable compound-containing liquid crystal composition being used for a liquid crystal display device including a pair of substrates, and the polymerizable compound-containing liquid crystal composition comprising the polymerizable compound,
wherein a liquid crystal alignment ability is provided by a polymer originating from the polymerizable compound in the polymerizable compound-containing liquid crystal composition disposed between the pair of substrates.

17. An optically anisotropic body formed by polymerizing the polymerizable composition according to claim 14.

18. A liquid crystal display device, comprising the polymerizable compound-containing liquid crystal composition according to claim 16, wherein the liquid crystal display device has a liquid crystal alignment ability provided by polymerizing the polymerizable compound in the polymerizable compound-containing liquid crystal composition.
